(19) United States
(12) Patent Application Publication
(10) Pub. No.: US 2021/0069050 A1
(43) Pub. Date: Mar. 11, 2021

(54) MEDICAL DEVICE FOR THE PREVENTION OF THROMBOSIS

(71) Applicant: THE TRUSTEES OF THE UNIVERSITY OF PENNSYLVANIA, Philadelphia, PA (US)

(72) Inventors: John D. Welsh, Philadelphia, PA (US); Mark L. Kahn, Bryn Mawr, PA (US)

(73) Assignee: THE TRUSTEES OF THE UNIVERSITY OF PENNSYLVANIA, Philadelphia, PA (US)

(21) Appl. No.: 17/095,370

(22) Filed: Nov. 11, 2020

Related U.S. Application Data
(63) Continuation of application No. PCT/US2019/032399, filed on May 15, 2019.
(60) Provisional application No. 62/671,905, filed on May 15, 2018.

(51) Int. Cl. A61H 1/02; A61H 9/00

(52) U.S. Cl. CPC A61H 1/0266; A61H 9/0078; A61H 2201/1207; A61H 2201/1238; A61H 2209/00; A61H 2201/5071; A61H 2201/0184; A61H 2201/1642; A61H 2201/165; A61H 2201/5056; A61H 2201/1678

(57) ABSTRACT

The presently disclosed subject matter provides a mechanism in which DVTs form when reduced muscular activity results in loss of oscillatory shear-dependent transcriptional and ant-thrombotic phenotypes in peri-valvular venous endothelial cells. Endothelial cells surrounding the venous valve, where DVTs originate, experience oscillatory shear forces in response to muscular activity. Peri-valvular venous endothelial cells express high levels of FOXC2 and PROX1, transcription factors known to be activated by oscillatory shear stress, exhibit an anti-thrombotic phenotype characterized by low levels of the procoagulant proteins von Willebrands Factor (vWF), P-selectin and intercellular adhesion molecule 1 (ICAM1), high levels of the anticoagulant proteins thrombomodulin (THBD), endothelial protein C receptor (EPCR) and tissue factor pathway inhibitor (TFPI), and resistance to thrombin-induced clot formation. The peri-valvular venous anti-thrombotic endothelial phenotype is lost following femoral artery ligation that reduces venous flow or genetic loss of FOXC2 or PROX1 in mice, and at the site of human DVT associated with lethal PE.

### CROSS-REFERENCE TO RELATED APPLICATIONS

This application is a continuation of International Patent Application No. PCT/US2019/032399, filed May 15, 2019, which claims priority from U.S. Provisional Patent No. 62/671,905, filed May 15, 2018, which are incorporated by reference herein.

### STATEMENT OF GOVERNMENT INTEREST

This invention was made with government support under National Institute of Health grants R01HL121650, P01HL120846, R01HL120872, T32HL07439, R01 HL126920, and R01HL073402 awarded by the National Institute of Health. The government has certain rights in the invention.

### BACKGROUND

Deep vein thrombosis (DVT) occurs when blood clots form in the sinus of venous valves. DVT can lead to pulmonary embolism (PE) when pieces of the clot break free and travel to a patient's lung causing injury and death. Together, DVT and PE are termed venous thromboembolism (VTE) and are a leading cause of death and disability worldwide. VTE is prevalent (>1%) in hospitalized patients with roughly 1 in 3 patients being at mild-high risk.

Hospitalized patients can be at high risk due to their illness, inflammation and cancers often increase clot formation, and their relative immobility. Immobility has been identified as a leading risk factor of DVT formation for over 150 years. Certain mechanical therapy devices have been designed to increase venous blood flow. Such devices can function by inducing a slow steady compression of a patient's foot, calf, and/or thigh. While this action can increase venous return, its ability to prevent clot formation is not well documented and it is not necessarily based on a specific mechanism of DVT formation. Notwithstanding continued use of certain mechanical therapy devices since the 1970's, VTE remains a leading cause of death for hospitalized patients.

Other DVT therapies include systemic anti-coagulation with low molecular weight heparin, or other anti-coagulants. However, such therapies can come along with a substantial bleeding risk that may not be tolerated in the hospitalized population at high risk for developing VTE such as post-operative or trauma patients.

Deep venous thrombosis (DVT) is a common vascular disease with an annual incidence of 0.1% among the general population, and >1% among hospitalized individuals. Pulmonary embolism (PE)—the blockade of pulmonary flow caused by a DVT that becomes dislodged and travels through the venous system to the lungs—is a common cause of cardiovascular death after myocardial infarction and stroke. Unlike myocardial infarction and stroke, DVT is not a thrombotic complication of atherosclerosis.

In 1856 Rudolph Virchow proposed a mechanistic triad for DVT pathogenesis that included stasis, defined as reduced venous blood flow associated with immobility, local vessel injury, and hypercoagulability. The role of hypercoagulability in DVT pathogenesis has since been demonstrated by the increased risk of DVT among individuals with gain of function mutations in clotting factors (e.g. Factor V Leiden), or activation of the clotting system by trauma, surgery, or circulating tissue factor positive tumor microparticles. In contrast, although epidemiologic studies have identified immobility as the strongest risk factor for DVT, neither a clear molecular basis for the role of stasis/immobility nor evidence of local vessel injury have been demonstrated in DVT pathogenesis.

An important clue regarding the pathogenesis of DVT was obtained over a half century ago when autopsy studies revealed that most DVTs originate in the sinus of venous valves, i.e. the space between the valve leaflet and adjacent vessel wall. Venography revealed that circulating blood is retained longer in the valve sinus than the non-valvular venous lumen, suggesting that this can predispose to clot formation at that site. These insights implicated the pen-valvular region of the vein in DVT formation, but a clear mechanistic understanding of the relationship between venous valves and DVT pathogenesis has been lacking. Accordingly, an improved technique for treating DVT is needed.

### SUMMARY

The disclosed subject matter utilizes the discovery that endothelial cells that line the venous valve sinus and adjacent valve leaflet experience reversing or oscillatory flow in response to muscular activity. Oscillatory shear forces drive expression of the FOXC2 and PROX1 transcription factors during lymphatic and venous valve development, and in accordance with the disclosed subject matter, high levels of such expression are detected in the peri-valvular venous endothelial cells of mature mice and humans. Venous peri-valvular endothelial cells also exhibit a strong anti-thrombotic phenotype characterized by low levels of the pro-thrombotic proteins von Willebrands Factor (vWF), P-selectin and intercellular adhesion molecule 1 (ICAM1), and high levels of the anti-thrombotic proteins thrombomodulin (THBD), endothelial protein C receptor (EPCR) and tissue factor pathway inhibitor (TFPI). Loss of this peri-valvular anti-thrombotic, anti-inflammatory endothelial phenotype is observed following loss of venous flow or genetic deletion of Foxc2 or Prox1 in mice, and in association with DVT formation in humans. Accordingly, a cellular and molecular explanation for observations regarding DVT pathogenesis is provided and used in the techniques disclosed herein.

The disclosed subject matter provides venous thromboembolism mitigation devices for generating venous valve oscillatory flow in the leg veins of an immobile person. In certain example embodiments, the device includes a foot holster having a flexion pad, an ankle brace, disposed on the foot holster, and a compression holder, disposed on the ankle brace. The device also includes an actuator, configured to flex the top of the foot dorsally into the compression holder/band in time intervals ranging from 0.1 seconds to 0.5 seconds. This timing has been analyzed carefully to determine the optimal conditions to specifically enhance valve sinus oscillatory/reversing flow as opposed to bulk venous return levels, which are enhanced at much slower times (greater than 1 second). The simultaneous rapid flexion and compression induced by the device generates venous valve oscillatory flow in the leg veins of the immobile person to preserve the natural mechanism of DVT prevention associated with muscular activity.

In certain embodiments, the extent of compression can be controlled by a material that can provide a progressive degree of resistance that connects a top plate and the compression holder to the foot holster. In some embodiments the material is elastic bands woven into fabric to provide increasing resistance during foot flexion but also provide comfortable skin contact with the top of the foot. The elasticity of the bands is selected so that no compression force is applied while the foot is not flexed, but that at least 100 mmHg of compression force is applied to the foot during full flexion. In certain embodiments, the actuator can be a mechanical actuator, a pneumatic actuator, a hydraulic actuator or an electric actuator. In certain embodiments, the mitigation device can include an elastic sock. In certain embodiments, the foot holster can be made of a rigid or semi-rigid plastic.

The presently disclosed subject matter also provides techniques for generating anti-thrombotic oscillatory flow in the venous valve sinus of an immobile person using venous thromboembolism mitigation devices having a foot holster, an ankle brace, a compression holder and an actuator. In certain embodiments, an example device includes an elastic sock, air muscles, and an air line attached to the air muscles via connectors. An exemplary method includes attaching the device to a foot of an immobile person, determining an optimal speed and extent of flexion of the foot to generate the venous valve oscillatory flow in the leg veins of the immobile person, and applying the optimal speed and extent of flexion and compression of the foot to the device. Vascular ultrasound imaging is used to quantify the amount of reversing flow within the valve sinus of the person wearing the device during the actuation period, and the reversing flow quantified as the percent (%) area of the valve sinus experiencing any reversing flow, and mean flow (mL/s·cm²) calculated by multiplying the velocity of the reversing flow (mL/s) and the area of reversing flow (cm²). The larger the area of reversing flow and larger amounts of reversing flow will be more effective at stimulating PROX1 and FOXC2 expression in the valve sinus endothelium, and providing enhanced protection from DVT formation.

The presently disclosed subject matter provides venous thromboembolism mitigation devices for generating venous valve oscillatory flow in the leg veins of an immobile person. In certain example embodiments, the device includes an inflation bladder, disposed within a wearable boot, adapted to inflate and deflate such that simultaneous rapid flexion and compression induced by the inflation bladder induces the venous valve oscillatory flow to preserve the natural mechanism of DVT prevention associated with muscular activity, and a head unit, pneumatically coupled to the inflation bladder, adapted to drive inflation and deflation of the inflation bladder.

In certain embodiments, the head unit further includes an air compressor and a compressed air tank, wherein the air compressor is adapted to fill the compressed air tank with compressed air to a pre-determined pressure and the compressed air tank is adapted to release the compressed air to the inflation bladder. In certain embodiments, the head unit also includes a solenoid valve, adapted to regulate the release of the compressed air from the compressed air tank to the inflation bladder. The head unit can include at least one pressure sensor, adapted to monitor air pressure of the compressed air tank and restore the air pressure to the pre-determined level, and at least one pressure relief valve, adapted to monitor air pressure of the inflation bladder and prevent over-inflation thereof.

In certain embodiments, the head unit further includes a control board, adapted to initiate inflation of the inflation bladder and to control parameters of inflation. The control of air flow is regulated by the pressure of the compressed air within the head unit, which is controlled by increasing the duration of air compressor activity to a set point, or relieving excess pressure through vents to a set point. The change in stored air pressure will impact the amount of air that flows into the inflation bladder during the opening of solenoid valves between the air storage tank in the head unit and the bladder. The time duration of the valve opening is also controlled electronically by the head unit. Altering the valve opening time effects both the amount of air that flows into the bladder and the duration of foot flexion. The head unit can also include an alarm system, adapted to detect a mechanical malfunction and to provide an audible alert in response to the mechanical malfunction. Using pressure sensors the stored air tank can be monitored to ensure that it is filling and maintaining stored air at the programmed pressure. Failure of the stored air tank to maintain proper pressures will result in an audible alarm to indicate a failure. In some embodiments the connection port between the head unit tubing and the foot flexion bladder will contain a pressure relief port that will vent air above a set pressure. The venting pressure is 150% of the pressure in the bladder during a set inflation event. The pressure relief port will vent any excess pressure in the system of the foot resists flexion, either actively or through reduced flexibility, to prevent bladder rupture or harmful over-flexion of the wearer's foot.

In certain embodiments, the wearable boot includes a rigid plastic frame, configured to attach to a foot of the immobile person and to extend to the ankle of the immobile person, and a compression band, configured to secure the foot of the immobile person to the rigid plastic frame. The compression band can be adapted to provide compression greater than 100 mmHg The rigid plastic frame can be configured to be covered in fabric and padding. The compression band can secure the foot of the immobile person to the wearable boot with a loop and hook material.

The inflation bladder can be wedge-shaped, shaped as a horizontal semi-cylinder such that a flat side of the inflation bladder is adapted to lie on a foot plate of the wearable boot, or shaped as a full cylinder such that the inflation bladder lays horizontally across a foot plate of the wearable boot. The inflation bladder is positioned to make contact primarily with the ball of the subject's foot to drive dorsiflexion. This dorsiflexion creates tightening of the calf muscle that provides vascular tone and induces venous return without vessel shutting from compression. There is an additive effect of the foot compression to drain blood from the plantar venous plexus to increase the bolus of venous flow. The bladder is positioned under the ball of the foot and such that it does not go under the heel pad or substantially under the sole of the foot. This design prevents lifting forces against the lower half of the foot that are incapable of flexing naturally about the ankle, and thus preventing forces that push the foot against the bottom of the boot. Forces in this direction cause discomfort of the foot pressing against stabilizing straps and limits the amount of flexion that occurs as the foot moves out of the boot. In one embodiment, the bladder is maintained at a minimum level of pressure (10 mmHg) that does not cause flexion and allows for more rapid refilling of the bladder with less noise of bladder movement.

### BRIEF DESCRIPTION OF THE FIGURES

FIGS. 1A-1C illustrate oscillatory flow in the venous valve sinus stimulated by muscular activity.

FIGS. 2A-2B illustrate FOXC2 and PROX1 which are specifically expressed in endothelial cells lining the venous valve leaflet and sinus in both mice and man.

FIGS. 3A-3K illustrate venous peri-valvular endothelium, which is highly anti-thrombotic in mouse and man.

FIGS. 4A-4C illustrate the strongly anti-thrombotic and anti-inflammatory properties of peri-valvular venous endothelium under biologically typical, healthy conditions.

FIGS. 5A-5D illustrate mean blood perfusion (FIG. 5C) and mean velocity of infused fluorescent beads (FIG. 5D) after mouse femoral artery ligation (FIG. 5A) and laser Doppler imaging (FIG. 5B).

FIGS. 6A-6F illustrate loss of the venous peri-valvular transcriptional and anti-thrombotic phenotypes as a result of femoral artery ligation.

FIGS. 7A-7F illustrate loss of FOXC2 resulting in loss of THBD and EPCR and gain of vWF without change in PROX1 or TFPI expression in peri-valvular venous endothelial cells.

FIGS. 8A-8F illustrate loss of PROX1 resulting in loss of TFPI without change in FOXC2, THBD, EPCR or vWF expression in peri-valvular venous endothelial cells.

FIGS. 9A-9D illustrate that loss of FOXC2 increases leukocyte rolling and thrombosis at the venous valve.

FIGS. 10A-10I illustrate human DVT arising in association with loss of the peri-valvular endothelial transcription factor and anti-thrombotic phenotypes.

FIGS. 11A-11B illustrate Foxc2^{VVKO} mice with normal blood coagulability.

FIGS. 12A-12E illustrate pressure changes in the opening and closing of valves in venous valve flow.

FIGS. 13A-13D illustrate venous valve flow measurements at the saphenous or common femoral vein valves in humans, a standard of care calf compression device and an exemplary venous thromboembolism (VTE) mitigation device used with different flexion and compression rates.

FIG. 14 illustrates an exemplary VTE mitigation device.

FIGS. 15A-15C illustrate the dorsiflexion, neutral and plantarflexion positions of an exemplary VTE mitigation device.

FIGS. 16A-16B illustrate exemplary VTE mitigation devices with mechanical (FIG. 16A) and motorized actuation (FIG. 16B).

FIGS. 16C-16D illustrate blood flow around a venous valve of the leg when the VTE mitigation device is in the relaxed (FIG. 16C) and flexed/compressed (FIG. 16D) positions.

FIGS. 17A-17C illustrate exemplary VTE mitigation devices with pneumatic, hydraulic or electric actuation.

FIG. 18A-18E illustrate an exemplary VTE mitigation device.

FIGS. 19A-19F illustrate hemodynamic conditions at venous valves in healthy human subjects.

FIG. 20A-20B illustrate an exemplary VTE mitigation device.

### DETAILED DESCRIPTION

Devices and methods for venous thromboembolism mitigation are presented. An inflation bladder is disposed within a wearable boot. The inflation bladder inflates and deflates to dorsiflex the foot of an immobile person. Dorsiflexion drives calf muscle tightening/lengthening to drive venous return of the blood volume within the calf. Dorsiflexion also causes a compressive force by pushing the foot into a compression band covering the top of the foot. This compressive force drains blood from the venous plantar plexus and increases the volume of venous blood returning to the heart from the leg. This simultaneous rapid flexion and compression generates venous valve oscillatory flow, in veins throughout the leg up into the groin area, to preserve the natural mechanism of deep vein thrombosis (DVT) prevention associated with muscular activity. For example, consistent actuation, to generate reversing flow, throughout a period of immobility, at intervals of at least ten (10) seconds of rest between actuations to allow for venous pressures to return to a steady state based on subject cardiac output, will provide biochemical and biophysical protection against DVT.

Muscular Activity Stimulates Oscillatory Blood Flow in the Venous Valve Sinus.

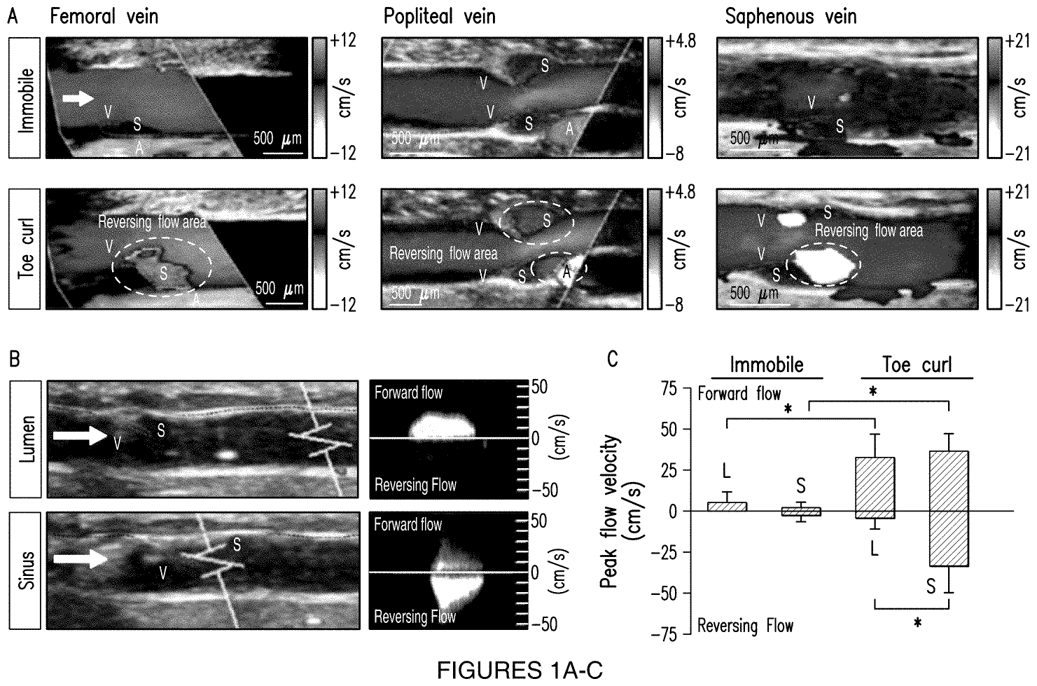

Immobility is a well-defined risk factor for DVT that has been proposed to lead to venous stasis, but deep venous blood flow remains high in the resting state due to pumping of the heart and basal cardiac output. To understand how immobility can function as a risk factor for DVT, blood flow in the veins of the human leg was examined under conscious, immobile conditions, and immediately following a single toe curl. Doppler ultrasound studies revealed that the leg veins of immobile individuals experience pulsatile forward flow in the lumen, with little oscillatory flow detected in the valve sinus (FIGS. 1A-C).

With reference to FIGS. 1A-1C for the purpose of illustration and not limitation, there is provided a schematic illustrating that oscillatory flow in the venous valve sinus is stimulated by muscular activity. With reference to FIG. 1A for the purpose of illustration and not limitation, there is provided a schematic illustrating 2D color Doppler studies of venous flow at the site of valves (V) and valve sinuses (S) in human femoral, popliteal and saphenous veins were performed in healthy individuals. The images are representative of three (3) femoral veins, seven (7) popliteal veins, and seven (7) saphenous veins studied in distinct individuals. Blood flow in the direction of circulation and reverse/oscillatory flow are shown. Flow measured when the individual was immobile (top) was compared with flow measured during muscular activity stimulated by a single toe curl (bottom). These data demonstrate that venous valve sinus flow is significantly altered in extent and pattern during immobility, which is a leading risk factor for DVT/VTE.

With reference to FIG. 1B for the purpose of illustration and not limitation, there is provided a schematic illustrating pulsed wave Doppler measurements of venous flow during muscular activity associated with toe curl that were measured at the venous lumen (L, top) and in the venous valve sinus (S, bottom). 2D Doppler shows the site of probe measurement (white dash, left). Pulse wave signals measured at the lumen (top) and valve sinus (bottom) are shown on the right. These data show that the reversing flow created by muscle movement is specific to the valve sinus region and does not occur in the lumen. The valve sinus is the specific site of DVT formation, and supports a model where valve sinus flow is impaired during immobility, and this altered flow pattern contributes to DVT formation.

With reference to FIG. 1C for the purpose of illustration and not limitation, there is provided a schematic illustrating peak forward and reverse flow velocities in the lumen (L) and sinus (S) under immobile and toe curl conditions were quantitated (N=7). Error bars indicate standard deviation and significance was determined by unpaired, two-tailed t-test. * indicates p<0.05. These data quantify the valve sinus specificity of reversing flow, which is absent from the non-sinus portions of veins.

With reference to FIGS. 1A-C for the purpose of illustration and not limitation, muscular activity stimulated forward flow in the lumen and a dramatic increase in the level of reversing or oscillatory flow in the sinus (S) behind the valve (V) leaflets of the femoral, popliteal and saphenous veins. Since autopsy studies identified the venous valve sinus as the site of DVT initiation, these findings support that physical immobility can alter the risk of DVT by reducing the level of oscillatory flow in the venous valve sinus.

Endothelial Cells Lining the Venous Valve Sinus Express High Levels of the FOXC2 and PROX1 Transcription Factors that are Regulated by Oscillatory Flow.

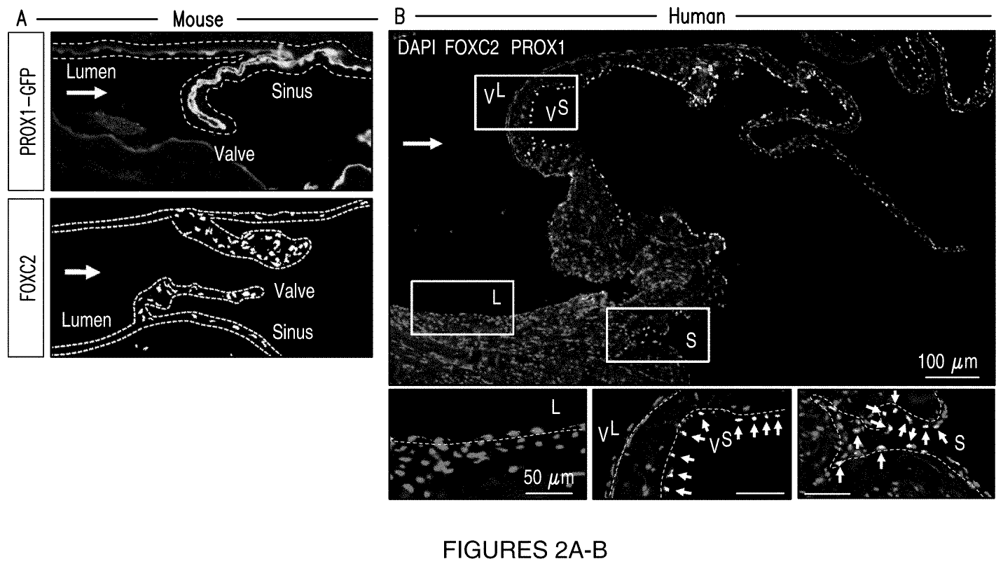

With reference to FIG. 2A for the purpose of illustration and not limitation, there is provided a schematic illustrating FOXC2 and PROX1 measurements in the mouse saphenous vein using anti-FOXC2 and anti-GFP immunostaining of wild-type and Prox1-GFP transgenic mice. (removed for clarity in gray scale images). White dotted lines indicate venous endothelial cells and peri-valvular endothelial cells, which are labeled Lumen, Valve, or Sinus to indicate the endothelial region. Arrows indicate the direction of venous blood flow. The images shown are representative of eight (8)_separate experiments using different animals.

Oscillatory shear stress (OSS), defined as the shear stress generated from flow conditions that over time has both periods of forward and reversing flow, which cells sense mechanically, has recently been demonstrated to stimulate the development of lymphatic valves through up-regulation of the FOXC2, GATA2 and PROX1 transcription factors, and sustained expression of FOXC2 and GATA2 is required to maintain lymphatic valves in the mature animal. Since venous valves are morphologically identical to lymphatic valves and also require FOXC2 and PROX1 to develop, an assessment was made regarding whether oscillatory flow detected in the venous valve sinus can be associated with ongoing expression of these transcription factors. Immunostaining of mouse saphenous veins from wild-type animals and PROX1-GFP transgenic reporter animals revealed that FOXC2 and PROX1 were highly expressed in endothelial cells lining both sides of the venous valve and the adjacent valve sinus, but were completely absent in non-valvular, luminal venous endothelium (FIG. 2A). Analysis of transgenic GATA2-GFP reporter animals also revealed specific expression in peri-valvular venous endothelial cells, but immunostaining with anti-GATA2 antibodies failed to detect a significant (p-value<0.05) difference between luminal and peri-valvular endothelial cells. These findings support a role for oscillatory shear stress, caused by recirculatory flow within the venous valve sinus, in activating PROX1 and FOXC2 expression specifically within the endothelial cells of the valve sinus.

With reference to FIG. 2B for the purpose of illustration and not limitation, there is provided a schematic illustrating FOXC2 and PROX1 were measurements in the human saphenous vein using anti-FOXC2 and anti-PROX1 antibodies. Staining at the venous lumen prior to the valve (L), the luminal face (V^{L}) and the sinus face (V^{S}) of the valve, and the sinus wall (S) are shown at higher magnification below. The images shown are representative of those obtained from studies of four (4) different individuals. White arrows indicate a nuclei that is double-positive for both PROX1 and FOXC2 staining. This data demonstrates that this expression pattern is conserved across mice and humans, supporting the biological importance of this pathway.

To determine whether and to what extent this peri-valvular expression pattern is conserved across species, the expression of these transcription factors in healthy human saphenous veins harvested for vascular bypass surgery was examined. As observed in the mouse, FOXC2 and PROX1 were detected in the nuclei of endothelial cells lining the sinus (S) and downstream/sinus side of the human saphenous venous valve leaflet (V^{S}), but not in non-valvular luminal venous endothelial cells (L) (FIG. 2B, white arrows). In contrast to the mouse, the endothelial cells lining the upstream/luminal side of the human venous valve leaflet (V^{L}) did not express FOXC2 or PROX1 (FIG. 2B).

These studies reveal that the FOXC2 and PROX1 transcription factors are strongly expressed in venous peri-valvular endothelial cells exposed to OSS, which was demonstrated in FIG. 1. These data support a model where the venous valve leaflet and sinus endothelium specifically express transcription factors activated by a unique hemodynamic environment that alters their thrombotic potential.

FOXC2+PROX1+ Peri-Valvular Venous Endothelial Cells Exhibit an Anti-Thrombotic, Anti-Inflammatory Phenotype.

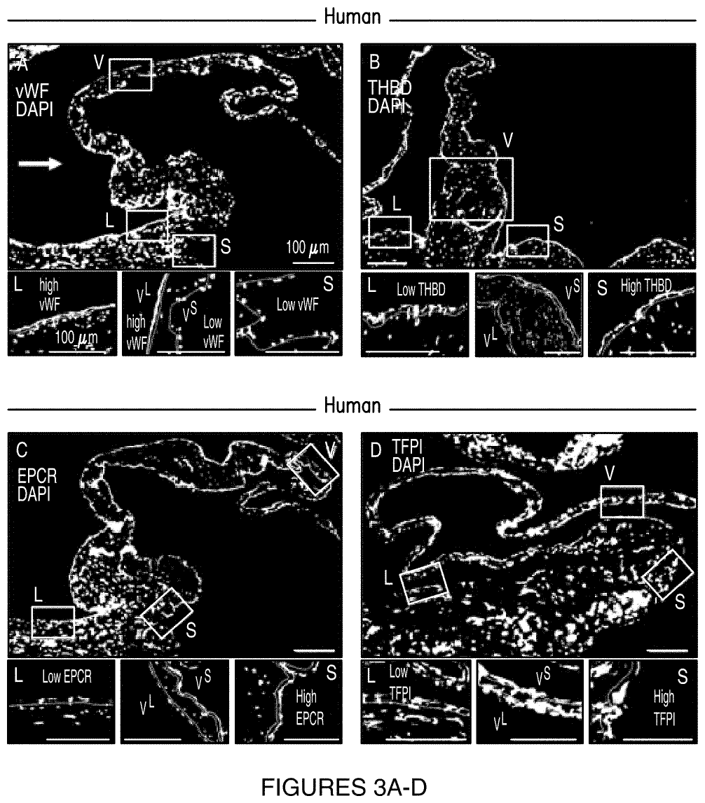

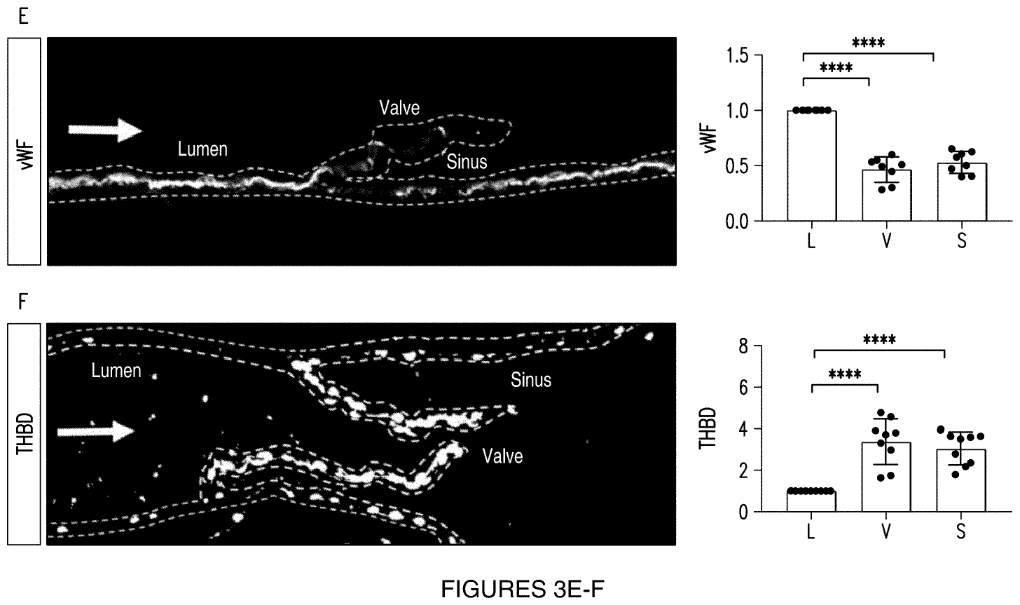

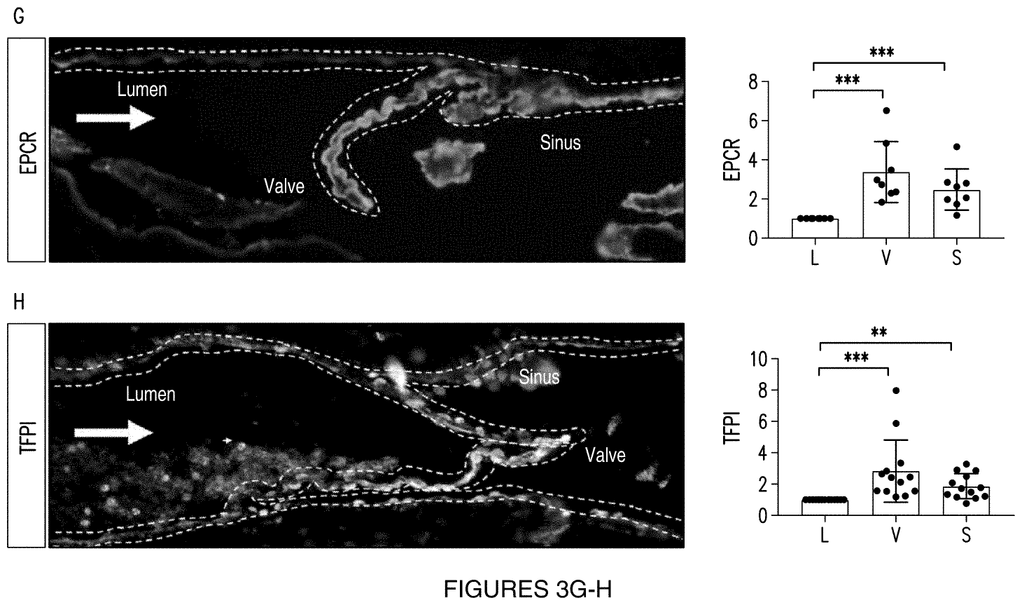

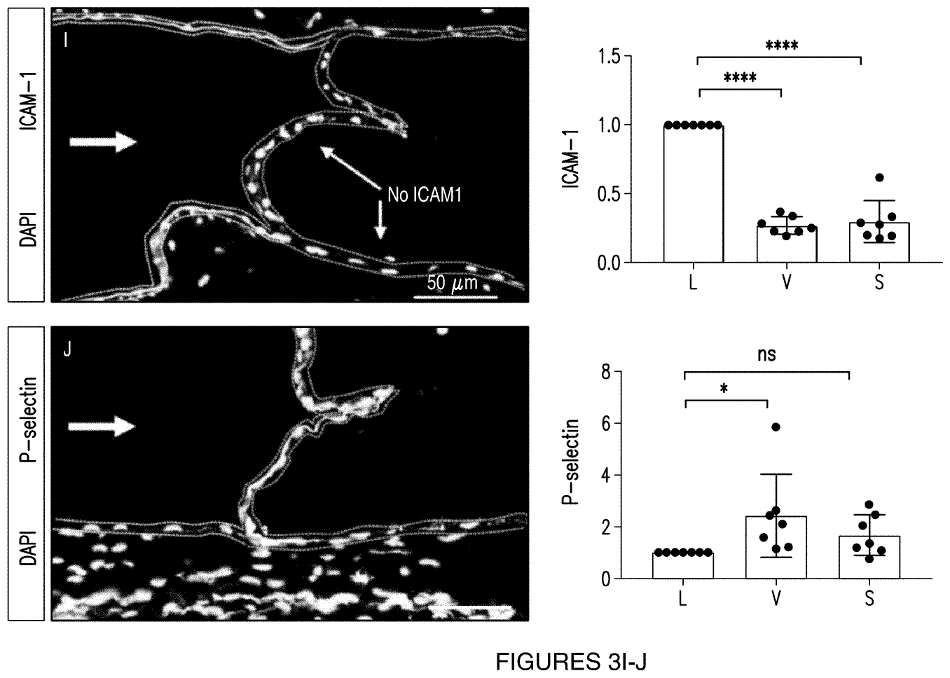

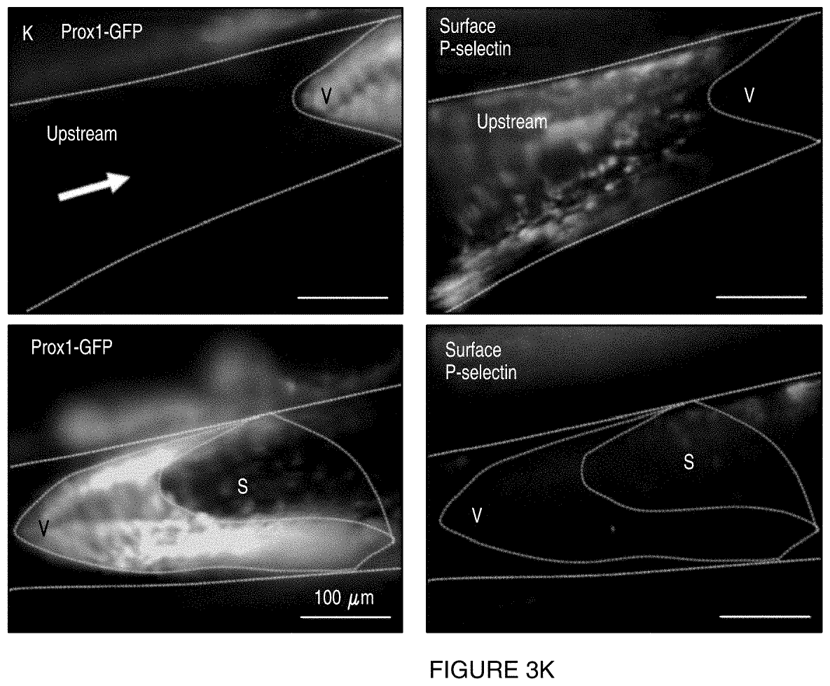

With reference to FIGS. 3A-3D for the purpose of illustration and not limitation, there is provided a schematic illustrating human saphenous veins immunostained to detect expression of vWF, THBD, EPCR and TFPI. Staining at venous lumen prior to the valve (L), the luminal face (V^{L}) and the sinus face (V^{S}) of the valve leaflet, and the sinus wall (S) are shown at higher magnification below. Labels indicate regions of high and low staining to assist in interpretation of gray scale images. This data demonstrates that the valve sinus endothelium in human veins of clinical significance express a characteristic pattern of anti-thrombotic proteins specifically in the valve sinus area.

With reference to FIGS. 3E-3H for the purpose of illustration and not limitation, there is provided a schematic illustrating mouse saphenous veins immunostained to detect expression of vWF, THBD, EPCR and TFPI. Relative quantitation of staining in luminal (L), valvular (V) and sinus (S) endothelial cells is shown to the right for each protein.

A recent study, from Dr. Bovill at the University of Vermont, reported that peri-valvular venous endothelial cells express low levels of the endothelial cell associated pro-coagulant protein vWF and high levels of the endothelial cell associated anti-coagulant proteins THBD and EPCR compared to the non-valvular surrounding endothelium, suggesting a protective anti-thrombotic nature of these cells. Immunostaining of human and mouse saphenous veins revealed dramatic loss of vWF expression and gain of THBD, EPCR and TFPI expression in peri-valvular endothelial cells compared with non-valvular, luminal endothelial cells in both species (FIGS. 3A-H). Significantly, these changes were observed specifically in the endothelial cells lining the valve sinus (S) and downstream/sinus side of the valve leaflet (V^{S}) in the human vein vs. those lining the sinus and both sides of the valve leaflet in the mouse vein, a pattern identical to that observed for expression of the shear-regulated transcription factors FOXC2 and PROX1 (FIG. 2B). These data clearly demonstrate that the venous valve leaflet and sinus endothelial cells that are exposed to reversing/oscillatory flow and express flow sensitive transcription factors also express a multi-protein anti-thrombotic phenotype, supporting a connection between local flow conditions and thrombotic potential of the endothelium.

With reference to FIGS. 31-3J for the purpose of illustration and not limitation, there is provided a schematic illustrating mouse saphenous veins immunostained to detect expression of the adhesion proteins ICAM1 and P-selectin. Relative quantitation of protein levels in luminal (L), valvular (V) and sinus (S) endothelial cells is shown to the right for each protein. These data show that the same region of cells that express flow regulated PROX1 and FOXC2, and have the anti-thrombotic phenotype, also express anti-inflammatory patterns of proteins. Inflammatory responses are also a critical aspect of DVT formation, further supporting this region as being resistant to DVT when PROX1 and FOXC2 expression are intact.

With reference to FIG. 3K for the purpose of illustration and not limitation, there is provided a schematic illustrating that P-selectin is not expressed on the surface of peri-valvular endothelial cells. Surface P-selectin was detected by intravenous injection of AlexaFluor 647-labelled anti-P-selectin antibodies into Prox1-GFP transgenic animals. Note that despite the high level of P-selectin protein detected intracellularly by staining of tissue sections (j), surface P-selectin was absent in Prox1-GFP+ peri-valvular endothelial cells. White dotted lines indicate luminal venous endothelial cells and gray dotted lines indicate peri-valvular endothelial cells. Arrows indicate the direction of venous blood flow. Error bars indicate standard deviation and significance was determined by the Ratio paired t-test. * indicates p<0.05; *** indicates p<0.005; **** indicates p<0.0001. These data show that the endothelial cells in the venous valve leaflet and sinus do not express surface P-selectin, which is required to support the biological function of P-selectin to recruit leukocytes and platelets to the surface of the endothelium. The lack of P-selectin and ICAM-1 expression makes these endothelium highly resistant to leukocyte rolling and adhesion, which has been proposed to be a causative event for DVT formation in the scientific literature. Previous studies have identified activated and adherent white blood cells as prothrombotic stimuli that when trapped within the valve sinus can support DVT formation. Thus our findings demonstrate that under healthy conditions activated white blood cell adhesion is blocked by the lack of ICAM1 and P-selectin surface expression on the local endothelium.

Since venous thrombi, including those that form at the venous valve, are known to incorporate adhesive leukocytes in addition to platelets and cross-linked fibrin, an assessment was made regarding endothelial expression of the pro-thrombotic leukocyte adhesion proteins P-selectin and ICAM1. As observed for the pro-thrombotic protein vWF, ICAM1 expression was markedly downregulated in the peri-valvular venous endothelium (FIG. 3I). P-selectin expression appeared maintained or even increased when examined in tissue sections (FIG. 3J), but intravascular injection of anti-P-selectin antibodies revealed dramatic loss of surface P-selectin in peri-valvular endothelial cells (FIG. 3K). This discrepancy between intracellular and surface P-selectin expression is consistent with studies demonstrating a requirement for vWF for surface expression of P-selectin, where the genetic deletion of vWF from all endothelial cells in mice resulted in a P-selectin surface expression deficiency and repressed inflammatory responses. These studies support (i) that the healthy peri-valvular venous endothelium is highly anti-thrombotic and anti-inflammatory, and (ii) that this unique endothelial phenotype is tightly associated with expression of the hemodynamically regulated FOXC2 and PROX1 transcription factors. The strong co-expression patterns of FOXC2 and PROX1 with the anti-thrombotic and anti-inflammatory gene expression in the endothelium suggest a causative relationship between the transcription factors and the protective phenotype of the perivalvular endothelium.

Healthy Peri-Valvular Venous Endothelium is Highly Anti-Thrombotic.

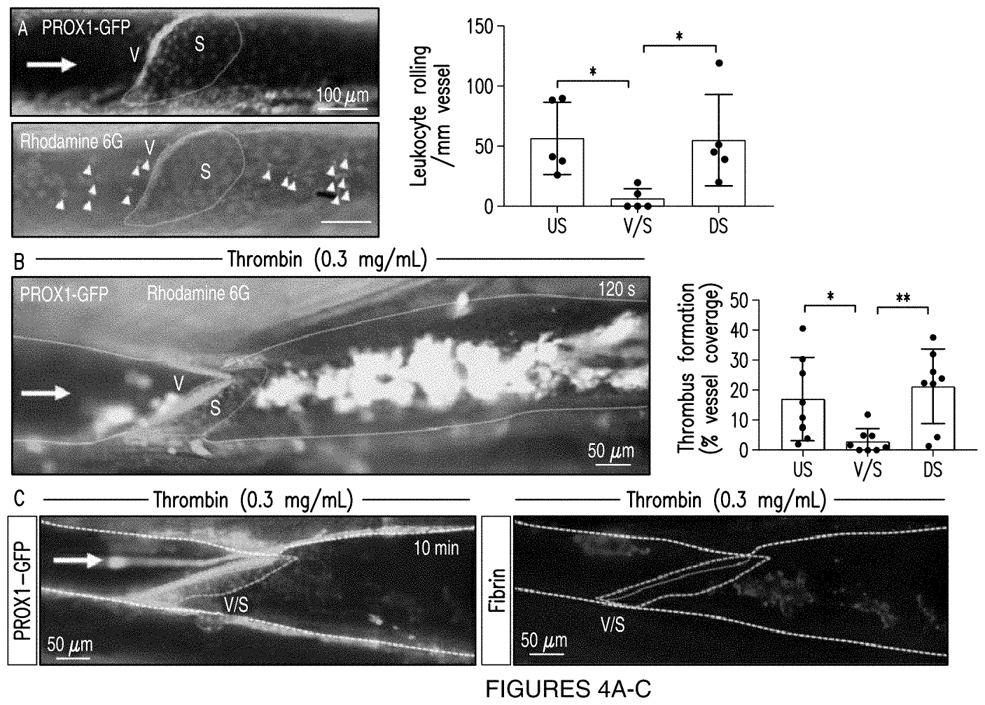

With reference to FIGS. 4A-4C for the purpose of illustration and not limitation, there is provided a schematic illustrating the strongly anti-thrombotic and anti-inflammatory properties of peri-valvular venous endothelium under biologically typical, healthy conditions.

To functionally test whether the endothelial molecular phenotype described above confers a localized anti-thrombotic phenotype to the venous valve, leukocyte rolling in the saphenous vein of live PROX1-GFP mice were observed, in which endothelial cells in the venous valve leaflets and sinus are marked by high GFP expression. Following injection of Rhodamine-6G, leukocyte rolling was observed both upstream and downstream of the venous valve and sinus, but no rolling leukocytes were observed on peri-valvular endothelium. To determine whether peri-valvular venous endothelium is more or less thrombotic than adjacent non-valvular venous endothelium, a low concentration of active thrombin (0.3 mg/ml) was applied to the exposed saphenous vein and thrombus formation detected using platelet and leukocyte uptake of rhodamine or anti-fibrin antibodies. Adherent thrombi were observed both upstream and downstream of the venous valve two minutes after thrombin application, but almost no clot formation was noted along the valve leaflets or in the valve sinus. Consistent with these observations, robust fibrin formation was detected upstream and downstream of the valve, but not at the valve itself ten minutes after thrombin application. These findings demonstrate that the peri-valvular venous endothelium is strongly anti-thrombotic and anti-inflammatory under biologically typical, healthy conditions. These are the same endothelial cells that express oscillatory/reversing shear stress driven transcription factor expression, further supporting the model that flow is driving this protective anti-thrombotic phenotype.

The Anti-Thrombotic Peri-Valvular Endothelial Phenotype is Conferred by Hemodynamic Forces.

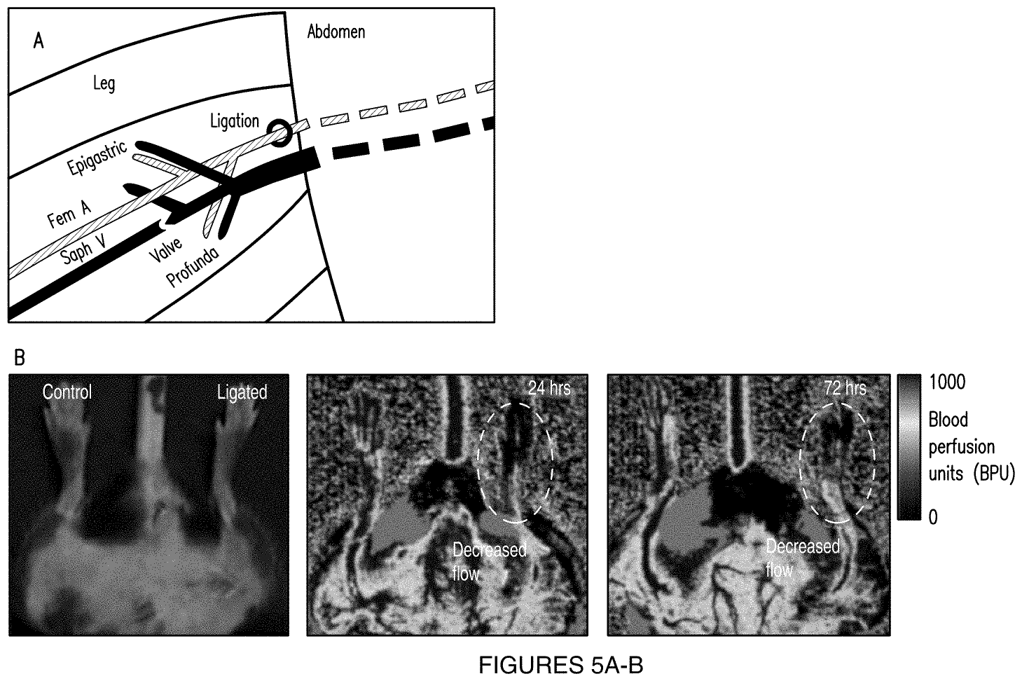

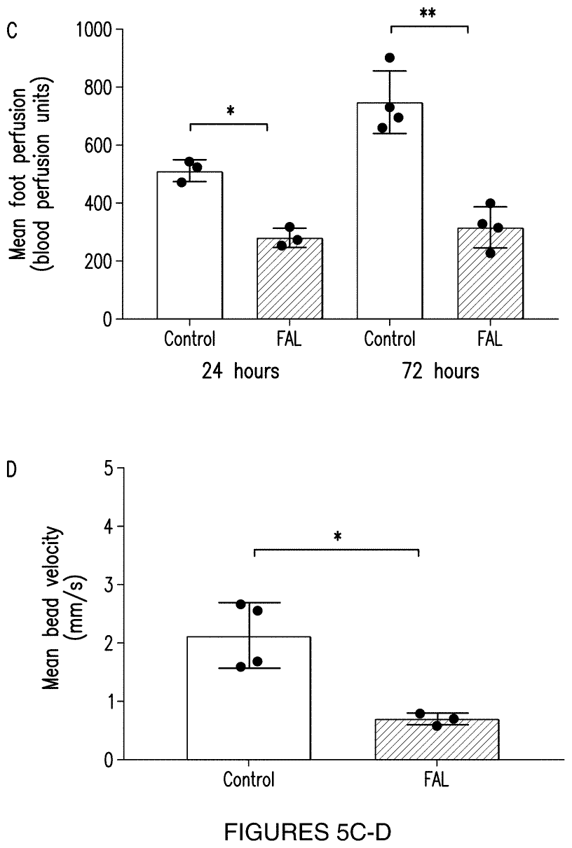

With reference to FIGS. 5A-5D for the purpose of illustration and not limitation, there is provided a schematic illustrating mean blood perfusion (FIG. 5C) and mean velocity of infused fluorescent beads (FIG. 5D) after mouse femoral artery ligation (FIG. 5A) and laser Doppler imaging (FIG. 5B).

The studies described above suggested that the distinct endothelial anti-thrombotic phenotype around the venous valve can be conferred by hemodynamic forces, such as OSS generated by periods of reversing flow within the sinus, that stimulate expression of FOXC2 and PROX1. To test an association between flow and expression of this transcriptional and anti-thrombotic endothelial phenotype at the venous valve, femoral artery ligation (FAL) was performed to transiently reduce both the level of blood flow in the vein and the level of muscular activity in the associated leg (due to hindlimb ischemia) (FIG. 5A). FAL resulted in an approximately 50% reduction in venous flow assessed at 72 hours by direct visualization of laser Doppler imaging (FIGS. 5B, C) and injected fluorescent beads (FIG. 5D). Transcription factor and coagulant protein expression were measured using immunostaining 72 hours after FAL to determine whether and to what extent their expression is dependent upon normal blood flow and hemodynamic forces. FOXC2 and PROX1 expression in peri-valvular endothelial cells were significantly reduced 72 hours after FAL, with FOXC2 expression being significantly reduced in the venous valve and trending down in the sinus and PROX1 reduced in the valve and brought to luminal levels in the sinus.

Expression of the anti-coagulant proteins THBD, EPCR and TFPI also dropped significantly in peri-valvular endothelial cells. Notably, expression of the pro-coagulant protein vWF rose in peri-valvular venous endothelial cells following FAL, demonstrating coordinate regulation of pro-coagulant and anti-coagulant gene expression, and suggesting that the reduced expression of transcription factors and anti-coagulant proteins is not likely to be a non-specific effect of reduced venous blood flow. FAL did not significantly alter the expression of ICAM1 in the peri-valvular endothelium (FIG. 3A). These studies support the conclusion that both the transcription factor and coagulation factor phenotypes that are unique to the peri-valvular venous endothelium are significantly regulated by hemodynamic conditions and limb muscular activity. These findings also support the conclusion that the loss of reversing/oscillatory flow in the venous valve sinus can contribute to DVT/VTE pathology.

Femoral Artery Ligation Results in Loss of the Venous Peri-Valvular Transcriptional and Anti-Thrombotic Phenotypes.

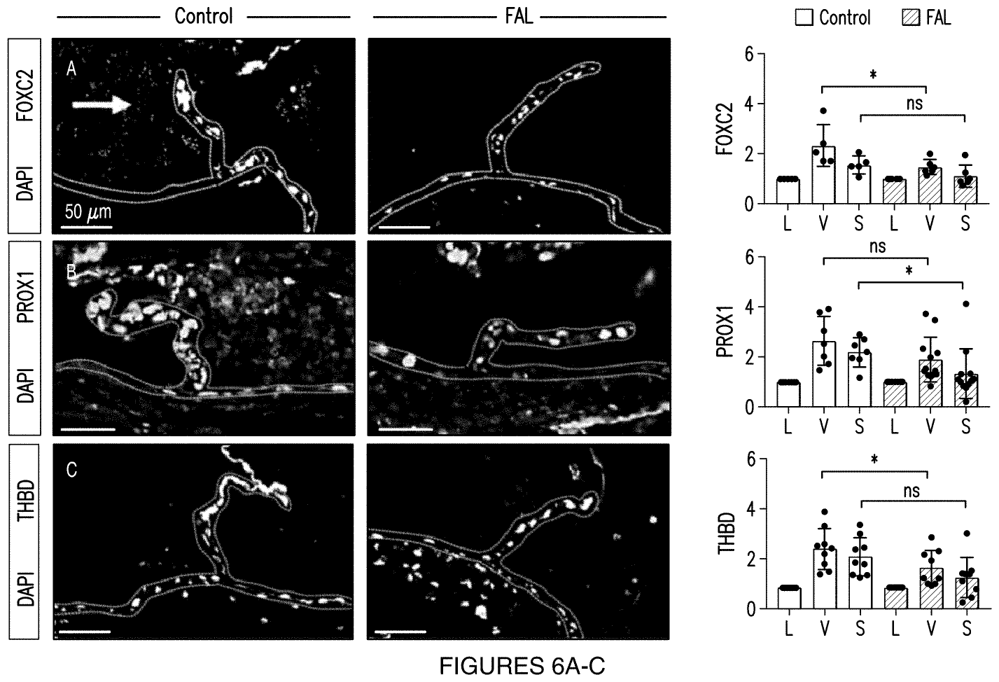

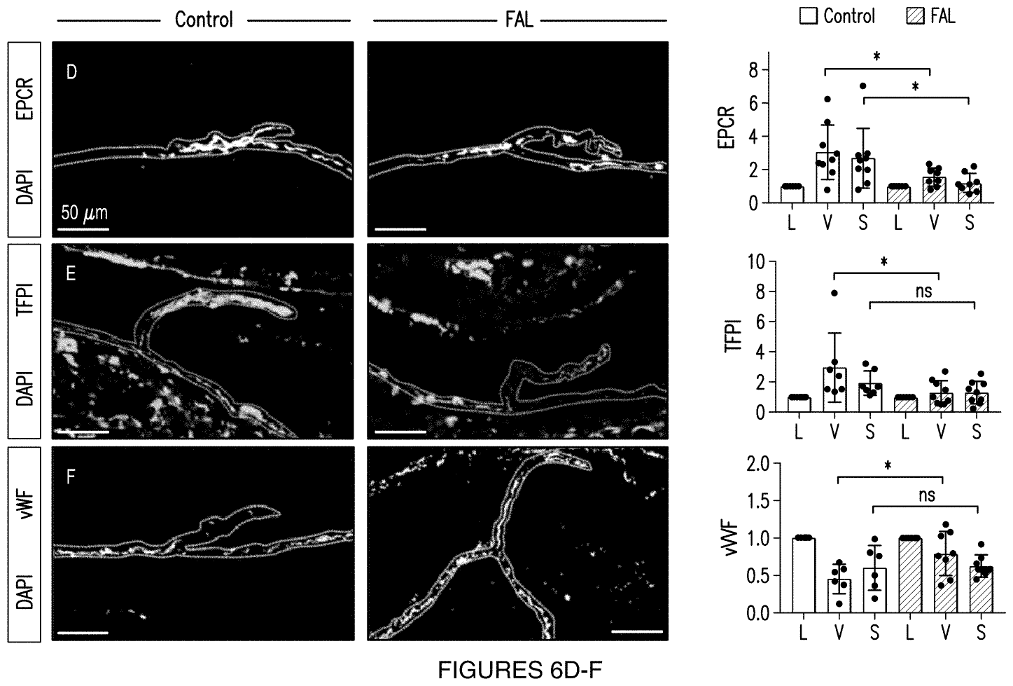

With reference to FIGS. 6A-6F for the purpose of illustration and not limitation, there is provided a schematic illustrating loss of the venous peri-valvular transcriptional and anti-thrombotic phenotypes as a result of femoral artery ligation (FAL). Immunostaining of mouse saphenous veins was performed 72 hours after FAL to reduce venous flow, and relative quantitation of protein levels in luminal (L), valvular (V) and sinus (S) endothelial cells measured.

With reference to FIGS. 6A-6B for the purpose of illustration and not limitation, there is provided a schematic illustrating that FAL results in loss of peri-valvular endothelial expression of the FOXC2 and PROX1 transcription factors.

With reference to FIGS. 6C-6E for the purpose of illustration and not limitation, there is provided a schematic illustrating that FAL results loss of peri-valvular endothelial expression of the anti-thrombotic proteins THBD, EPCR and TFPI.

With reference to FIG. 6F for the purpose of illustration and not limitation, there is provided a schematic illustrating that FAL results in gain of peri-valvular endothelial expression of the pro-thrombotic protein vWF. White dotted lines indicate luminal venous endothelial cells and gray dotted lines indicate peri-valvular endothelial cells. Error bars indicate standard deviation and significance was determined by an unpaired two-tailed Mann-Whitney test. ns indicates no significant difference; * indicates p<0.05; ** indicates p<0.01; *** indicates p<0.005; **** indicates p<0.0001.

FOXC2 and PROX1 Maintain the Anti-Thrombotic Phenotype in Peri-Valvular Venous Endothelial Cells.

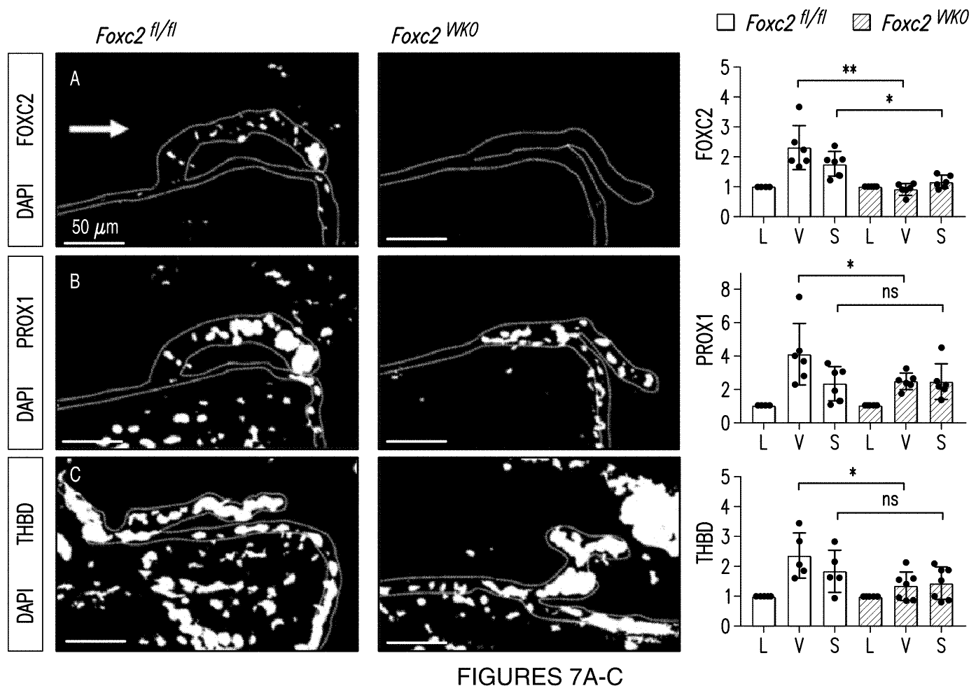

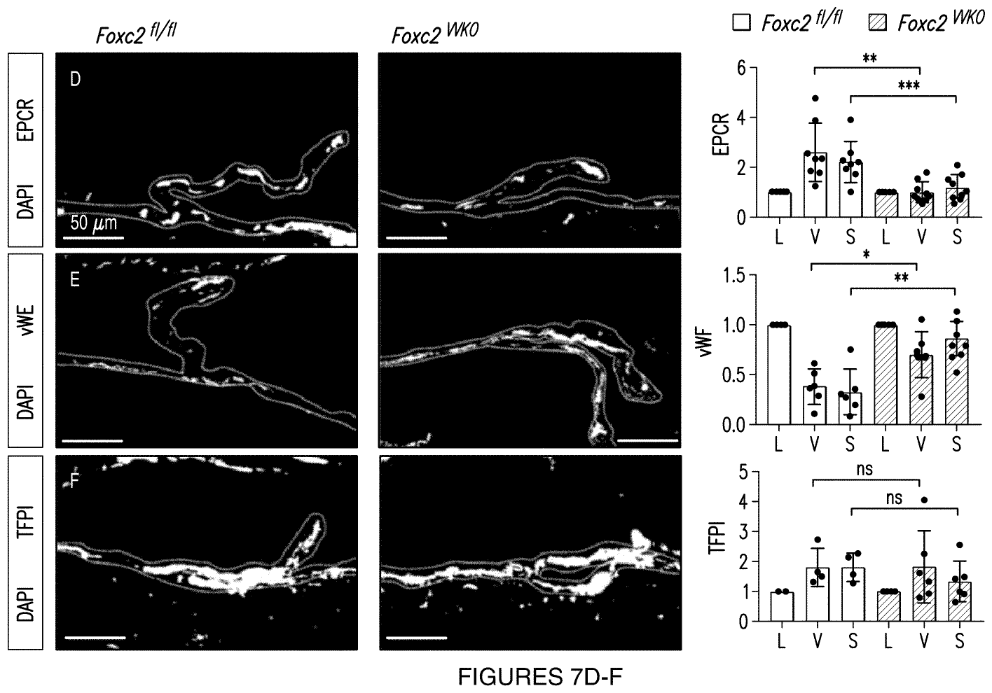

With reference to FIGS. 7A-7F for the purpose of illustration and not limitation, there is provided a schematic illustrating immunostaining of mouse saphenous veins performed in animals lacking FOXC2 in peri-valvular venous endothelial cells (Foxc2^{VVKO} mice) and littermate controls (Foxc2^{fl/fl} mice).

With reference to FIGS. 7A-7B for the purpose of illustration and not limitation, there is provided a schematic illustrating that loss of FOXC2 reduces peri-valvular endothelial expression of PROX1.

With reference to FIGS. 7C-7E for the purpose of illustration and not limitation, there is provided a schematic illustrating that loss of FOXC2 results in loss of increased levels peri-valvular endothelial expression of the anti-thrombotic proteins THBD and EPCR and gain of expression of the pro-thrombotic protein vWF. The levels become comparable to the surrounding non-valvular endothelium.

With reference to FIG. 7F for the purpose of illustration and not limitation, there is provided a schematic illustrating that loss of FOXC2 does not significantly alter the expression of the anti-thrombotic protein TFPI. White dotted lines indicate luminal venous endothelial cells and gray dotted lines indicate peri-valvular endothelial cells. Error bars indicate standard deviation and significance was determined by an unpaired two-tailed Mann-Whitney test. ns indicates no significant difference; * indicates p<0.05; ** indicates p<0.01; *** indicates p<0.005; **** indicates p<0.0001.

The studies described above suggested that the transcription factors FOXC2 and PROX1 couple hemodynamic forces to a strong anti-thrombotic, anti-inflammatory phenotype in the endothelial cells of venous valve leaflets and sinus. To test the role of this transcriptional mechanism at the venous valve in vivo, Foxc2 was deleted in the PROX1+ peri-valvular venous endothelial cells of Prox1-CreERT2; Foxc2^{fl/fl} mature animals (termed “Foxc2^{VVKO}” animals). Consistent with published studies, three (3) weeks after tamoxifen-induced gene deletion Foxc2^{VVKO} animals appeared healthy, had no loss of venous valves, and displayed no signs of edema, ascites or lymphatic dysfunction. FOXC2 protein expression was not detectable in the peri-valvular venous endothelial cells of Foxc2^{VVKO} animals, while PROX1 expression was significantly reduced in the valve endothelium but remained elevated compared to luminal endothelium (FIGS. 7A, B). As observed following FAL to alter venous hemodynamics in wild-type animals, peri-valvular endothelial cells in Foxc2^{VVKO} animals exhibited reduced expression of the anti-thrombotic proteins THBD and EPCR, but increased expression of the pro-thrombotic protein vWF (FIGS. 7C-E). Notably, peri-valvular TFPI expression was not significantly altered in Foxc2^{VVKO} animals (FIG. 7F). These findings support the conclusion that reversing/oscillatory flow in the venous valve sinus driving FOXC2 expression regulates the valve sinus anti-thrombotic gene expression. These findings are significant as forward flow alone was long considered the “healthy” condition for venous return, and that reversing flow elements were inefficient for this process. Here, we demonstrate for the first time that these reversing flow patterns activate a potent anti-thrombotic phenotype conserved across species to prevent valve sinus thrombosis. This also supports the concept that reversing flow creation in the valve sinus could be a therapy for immobilized persons to maintain expression of FOXC2 and PROX1 and the downstream anti-thrombotic genetic program to protect against DVT formation and secondary pulmonary embolism.

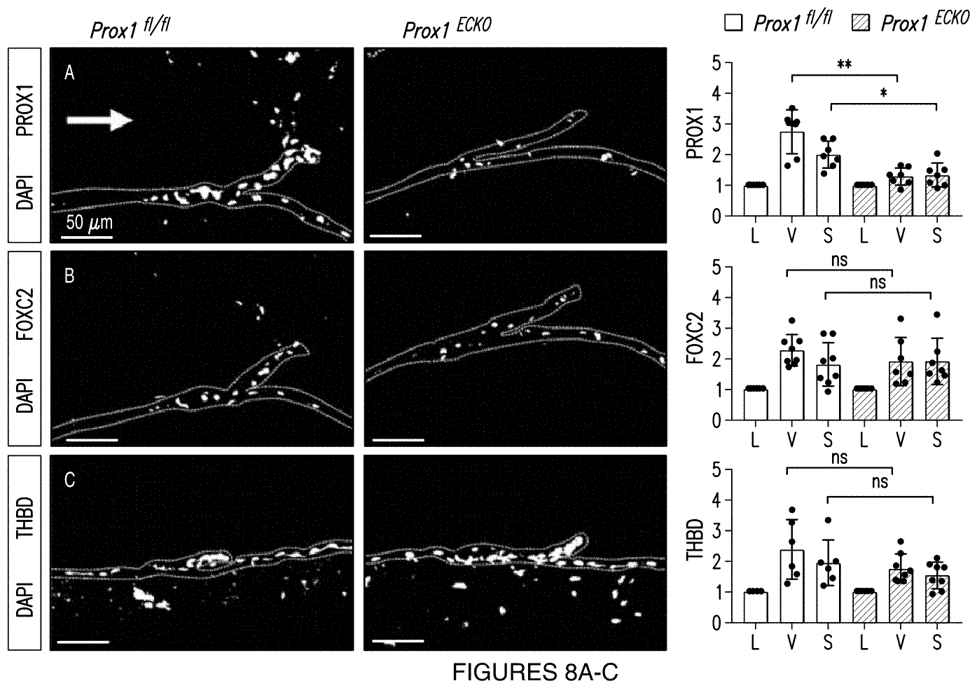

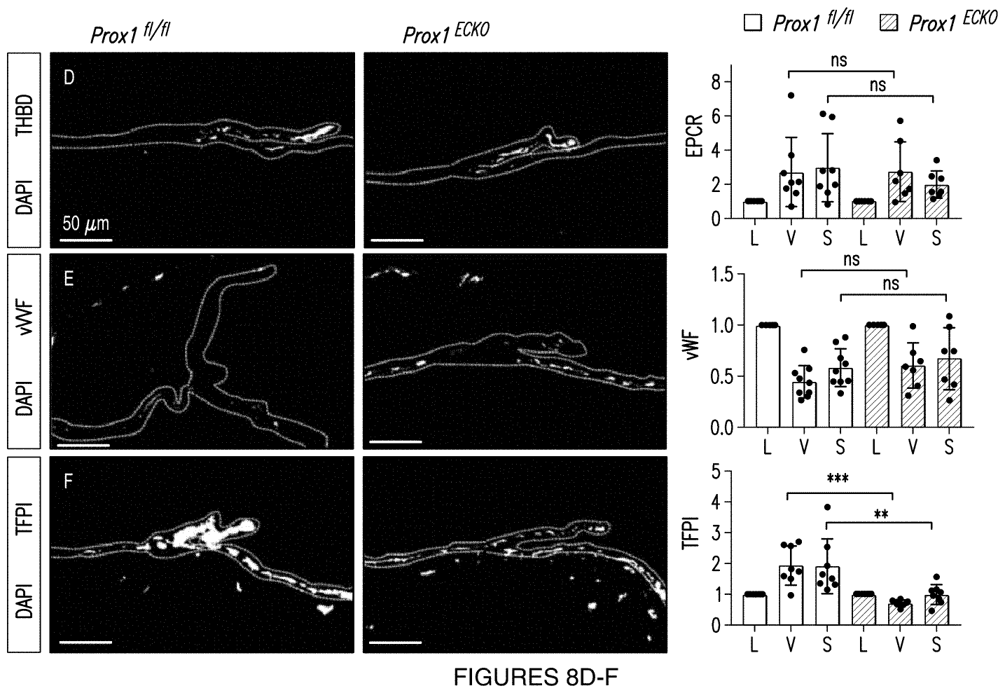

With reference to FIGS. 8A-8F for the purpose of illustration and not limitation, there is provided a schematic illustrating immunostaining of mouse saphenous veins was performed in animals lacking PROX1 in endothelial cells (Prox1^{ECKO} mice) and littermate controls (Prox1^{fl/fl} mice).

With reference to FIGS. 8A-8B for the purpose of illustration and not limitation, there is provided a schematic illustrating that loss of PROX1 does not alter peri-valvular endothelial expression of FOXC2.

With reference to FIGS. 8C-8E for the purpose of illustration and not limitation, there is provided a schematic illustrating that loss of PROX1 does not change peri-valvular endothelial expression of the anti-thrombotic proteins THBD and EPCR or the pro-thrombotic protein vWF.

With reference to FIG. 8F for the purpose of illustration and not limitation, there is provided a schematic illustrating loss of PROX1 resulting in loss of expression of the anti-thrombotic protein TFPI. White dotted lines indicate luminal venous endothelial cells and gray dotted lines indicate peri-valvular endothelial cells. Error bars indicate standard deviation and significance was determined by an unpaired two-tailed Mann-Whitney test. ns indicates no significant difference; * indicates p<0.05; ** indicates p<0.01; *** indicates p<0.005; **** indicates p<0.0001.

To assess the role of PROX1 in maintaining the peri-valvular anti-thrombotic endothelial phenotype described above saphenous venous valves from Cdh5-CreERT2; Prox1^{fl/fl} mature animals (termed “Prox1^{ECKO}” animals) were analyzed. Prox1^{ECKO} venous valves exhibited loss of endothelial PROX1 expression (FIG. 8A) but retained expression of FOXC2 in peri-valvular endothelial cells (FIG. 8B). Unlike loss of FOXC2, loss of PROX1 did not significantly lower the expression of THBD or EPCR or raise the expression of vWF in peri-valvular endothelial cells (FIGS. 8C-E). However, loss of PROX1 did significantly reduce peri-valvular expression of TFPI (FIG. 8F), a protein that was not significantly altered with loss of FOXC2 (FIG. 7F). Neither loss of FOXC2 nor loss of PROX1 altered ICAM1 expression. These studies demonstrate requirements for both FOXC2 and PROX1 for the anti-thrombotic phenotype of peri-valvular venous endothelial cells, and support that they function in discrete ways in this context. These findings further support the model of modifying venous flow to increase valve sinus recirculatory/oscillatory flow in immobile persons would support the endothelial expression of PROX1 and FOXC2, which would individually upregulate various aspects of the anti-thrombotic genetic program.

Loss of FOXC2 Predisposes to Venous Peri-Valvular Thrombosis

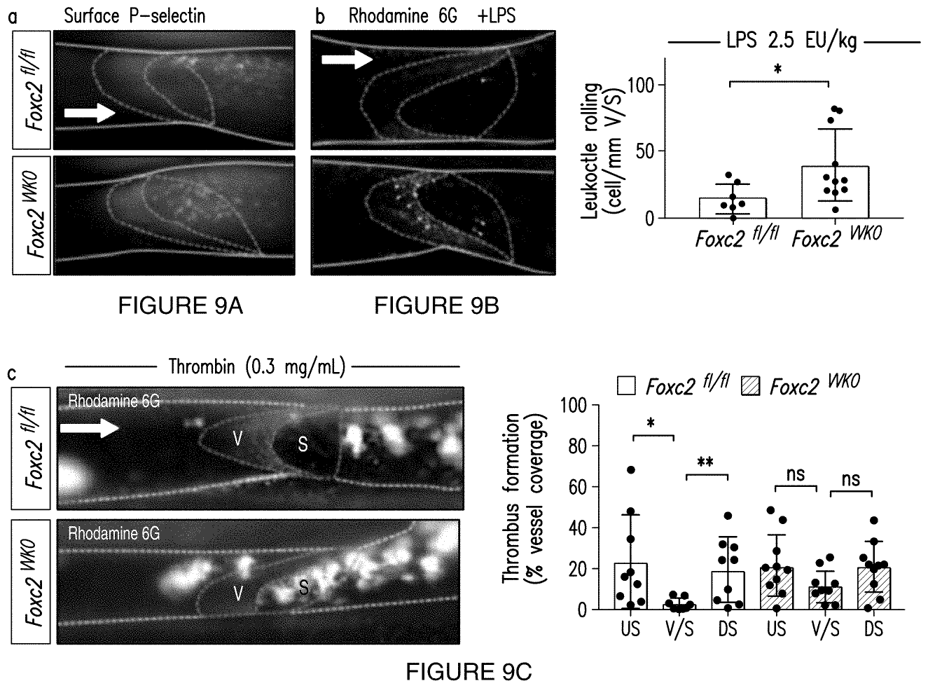

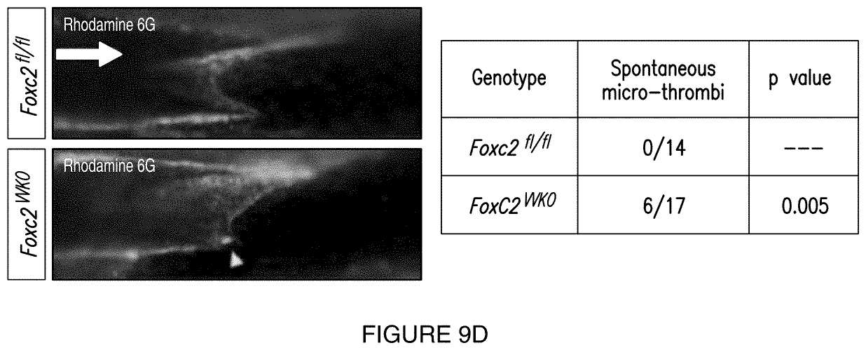

With reference to FIG. 9A for the purpose of illustration and not limitation, there is provided a schematic illustrating surface P-selectin expression at the venous valve leaflet and sinus endothelium in animals lacking FOXC2 in peri-valvular venous endothelial cells (Foxc2^{VVKO} mice) and littermate controls (Foxc2^{fl/fl} mice) using intravital imaging of labeled anti-P-selectin antibody as previously described. The Foxc2^{fl/fl} valve leaflet and sinus endothelium do not express surface P-selectin, consistent with previous findings. However, the Foxc2^{VVKO} mice that have lost FOXC2 expression now readily expression surface P-selectin in the valve sinus region. Arrow indicates direction of flow. Dotted lines outline the valve sinus region. This image is representative of six (6) similar experiments.

With reference to FIG. 9B for the purpose of illustration and not limitation, there is provided a schematic illustrating a leukocyte rolling after administration of the pro-inflammatory agent lipopolysaccharide (LPS) at the saphenous venous valve was measured in animals lacking FOXC2 in peri-valvular venous endothelial cells (Foxc2^{VVKO} mice) and littermate controls (Foxc2^{fl/fl} mice) using Rhodamine 6G. Arrow indicates direction of flow. Dotted lines outline the valve sinus region and arrowheads indicate leukocytes adherent to the vessel wall. This image is representative of multiple experiments (n=7 for Foxc2^{fl/fl} mice and n=11 Foxc2^{VKKO} mice. These data support the conclusion that the loss of FOXC2 increases the inflammatory and thrombotic potential of the valve sinus region, and further supports the role of FOXC2 stimulation through hemodynamics as a potent therapy to prevent thrombo-inflammatory clot formation associated with DVT/VTE pathology.

Since FOXC2 is tightly controlled by hemodynamic forces at the venous valve and Foxc2^{VVKO} animals exhibited the most significant loss of the anti-thrombotic phenotype in peri-valvular endothelial cells (FIG. 7), the question of whether loss of FOXC2 can predispose toward venous thrombosis in vivo was considered. In contrast to Foxc2^{fl/fl} control littermates, Foxc2^{VVKO} animals expressed P-selectin on the surface of peri-valvular endothelial cells (FIG. 9A). Foxc2^{VVKO} animals also exhibited higher levels of leukocyte rolling over peri-valvular venous endothelial cells than control littermates following injection of a low dose of lipopolysaccharide (LPS), a known activator of vascular endothelium (FIG. 9B), indicating that loss of FOXC2 reverses the venous peri-valvular anti-inflammatory phenotype.

With reference to FIG. 9C for the purpose of illustration and not limitation, there is provided a schematic illustrating thrombus formation at the saphenous venous valve stimulated by application of extravascular thrombin was measured in animals lacking FOXC2 in peri-valvular venous endothelial cells (Foxc2^{VVKO} mice) and littermate controls (Foxc2^{fl/fl} mice) using Rhodamine 6G (left). The percentage of vessel area covered by thrombus was measured upstream of the valve (US), in the valve and valve sinus regions (V/S), and downstream of the valve (DS) (right). These data further support the role of flow-activated FOXC2 expression in preventing venous valve thrombosis and DVT formation.

With reference to FIG. 9D for the purpose of illustration and not limitation, there is provided a schematic illustrating the presence of peri-valvular spontaneous microthrombi in animals lacking FOXC2 in peri-valvular venous endothelial cells (Foxc2^{VVKO} mice) and littermate controls (Foxc2^{fl/fl} mice) was detected using Rhodamine 6G. Error bars indicate standard deviation and significance was determined by unpaired, two-tailed t-test. ns indicates no significant difference; * indicates p<0.05; ** indicates p<0.01.

To examine the local thrombotic effects of FOXC2 deficiency in the peri-valvular endothelium, testing for protection against thrombin-induced clot formation was performed. In contrast to control littermates, Foxc2^{VVKO} animals exhibited clot formation in both the valve sinus and on the valve leaflets (FIG. 9B), indicating loss of the functional anti-thrombotic phenotype associated with FOXC2+ peri-valvular endothelial cells (FIG. 9B). Significantly, live imaging revealed spontaneous micro-thrombi along the valve leaflets and sinus in 6/17 Foxc2^{VVKO} animals versus 0/14 Foxc2^{fl/fl} controls (FIG. 9C). No change in systemic clotting was observed using either the APTT or fibrin clot time in Foxc2VVKO animals (FIG. 9D). This provides genetic evidence for a mechanism in which expression of the FOXC2 transcription factor supports a strong anti-thrombotic, anti-inflammatory phenotype in peri-valvular endothelium. These findings directly link flow driven expression of FOXC2 with physiological thrombus formation specifically at venous valves, which is the site of DVT formation in human patients.

Human DVT is Associated with Reversal of the Peri-Valvular Endothelial Transcription Factor and Anti-Thrombotic Phenotypes.

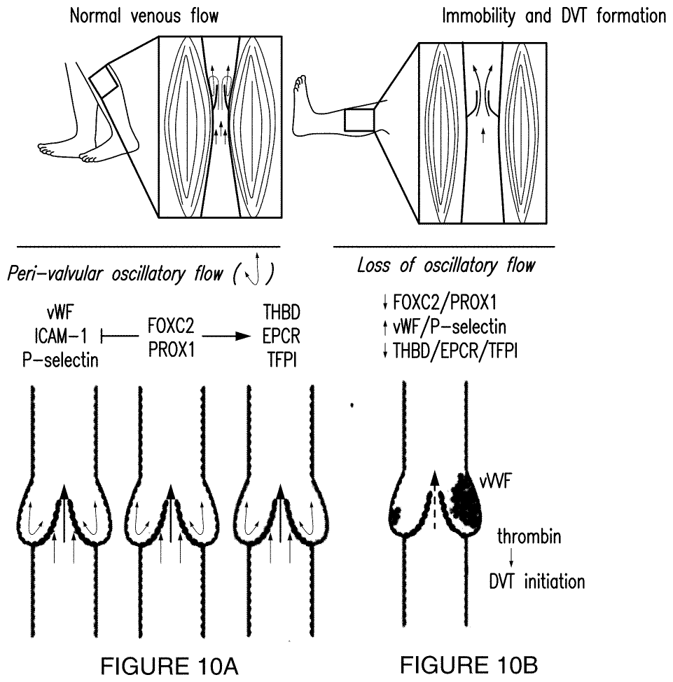

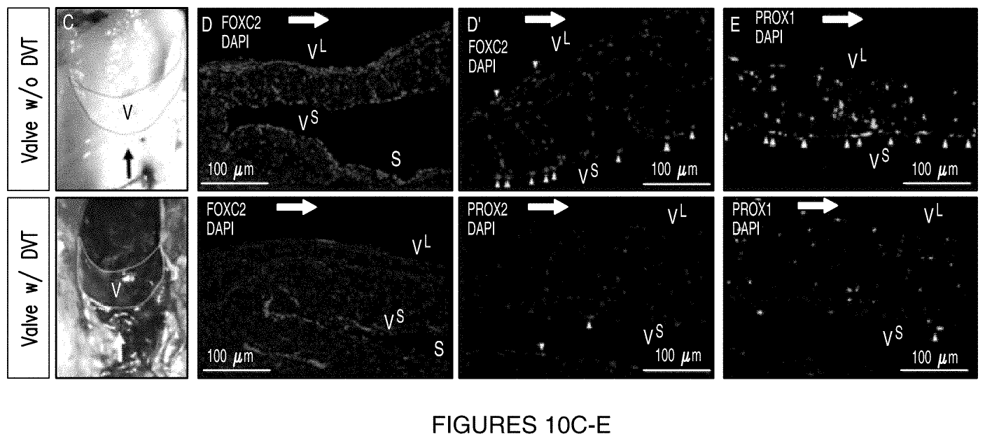

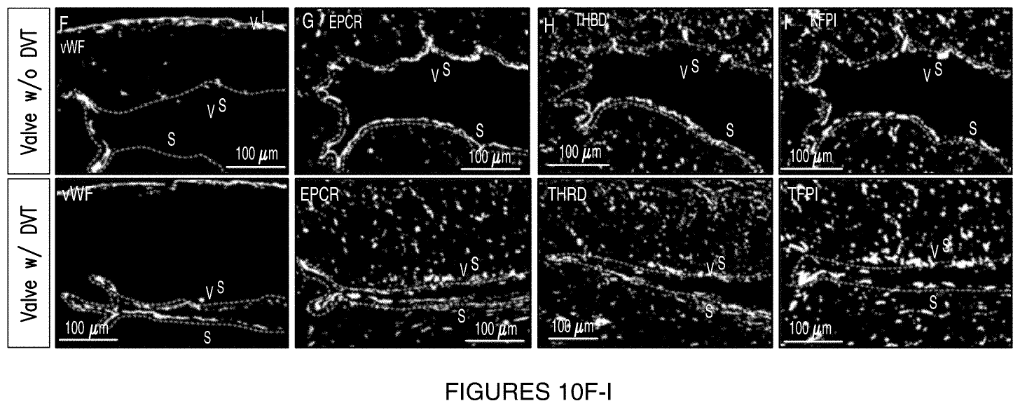

With reference to FIGS. 10A-10B for the purpose of illustration and not limitation, there is provided a schematic illustrating a model of the relationship between muscular activity, peri-valvular oscillatory flow, peri-valvular endothelial cell gene expression and venous thrombosis. In an active state certain muscular activity stimulates reversing flow in the venous valve sinus, creating oscillatory shear stress sensed by the local endothelium and driving endothelial expression of the shear-regulated FOXC2 and PROX1 transcription factors. Shear-regulated transcription factor activity upregulates expression of the anti-thrombotic proteins THBD, EPCR and TFPI while simultaneously downregulating expression of the pro-thrombotic proteins vWF, P-selectin and ICAM1 to maintain a highly anticoagulant environment (FIG. 10A). Inactivity and lack of certain muscular contraction results in peri-valvular endothelial loss of expression of the shear-regulated transcription factors, loss of THBD, EPCR and TFPI expression, and gain of vWF, P-selectin and ICAM1 expression, resulting in thrombin generation and formation of DVT (FIG. 10B).

With reference to FIGS. 10C-10E for the purpose of illustration and not limitation, there is provided a schematic illustrating human DVT is associated with loss of endothelial expression of FOXC2 and PROX1 in the valve sinus.

With reference to FIG. 10C for the purpose of illustration and not limitation, there is provided a schematic illustrating after death due to pulmonary embolism, femoral vein samples containing a valve were harvested from a leg without DVT (top) and from the contralateral leg with DVT in situ (bottom).

With reference to FIGS. 10D-10E for the purpose of illustration and not limitation, there is provided a schematic illustrating immunostaining for FOXC2 and PROX1 performed on sections from the valves shown in (c). Arrowheads indicate FOXC2+ and PROX1+ nuclei.

With reference to FIGS. 10F-10I for the purpose of illustration and not limitation, there is provided a schematic illustrating DVT associated with endothelial gain of expression of the pro-thrombotic protein vWF and loss of the anti-thrombotic proteins THBD, EPCR and TFPI in the valve sinus. The white dotted line indicates the endothelial layer. V^{L}, luminal face of the valve. V^{S}, sinus face of the valve. S, vessel wall in the valve sinus.

The studies of human and mouse peri-valvular endothelial gene expression and the mouse functional and genetic studies described above support a model in which oscillatory hemodynamic forces stimulated by muscular activity normally prevent venous thrombus formation by maintaining expression of the FOXC2 and PROX1 transcription factors and a powerful anti-thrombotic phenotype in peri-valvular endothelial cells (FIGS. 10A, B). Such a model predicts that human DVT would be associated with a reversal of these unique peri-valvular venous endothelial phenotypes, as observed in mice following FAL or genetic loss of FOXC2 or PROX1. To test this prediction, the femoral veins of a 74-year-old individual who died suddenly due to DVT and associated pulmonary embolism was examined. At autopsy, a large DVT was observed originating from the valve at the junction of the right superficial and deep femoral veins (FIG. 10C bottom), while the equivalent valve in the left leg did not have an associated DVT (FIG. 10C top). Histologic analysis revealed high FOXC2, PROX1, THBD, EPCR and TFPI expression and low vWF expression in the endothelial cells lining the unaffected left femoral venous valve sinus and V^{S} leaflet (FIGS. 10D-I top), a pattern identical to that observed in the healthy human saphenous vein (FIG. 2). In contrast, the endothelial cells lining the right femoral venous valve sinus and V^{S} leaflet exhibited loss of FOXC2, PROX1, THBD, EPCR and TFPI expression and gain of vWF expression (FIGS. 10D-I bottom). Identical molecular findings were observed in a second individual who also died of DVT and fatal pulmonary embolism. These findings are consistent with a causal role for loss of the peri-valvular endothelial transcription factor and anti-thrombotic phenotype in the pathogenesis of human DVT and venous thromboembolism.

The concept that venous stasis associated with physical immobility is a major factor in DVT pathogenesis has been appreciated for over 150 years, but a mechanistic basis for this observation has not been established. The disclosed subject matter demonstrates that hemodynamic forces, specifically reversing/recirculatory flow, generated around venous valves by certain muscular activity maintain expression of the hemodynamically regulated transcription factors FOXC2 and PROX1 that confer a powerful anti-thrombotic endothelial phenotype in the valve sinus, the known site of DVT origin. In mice certain levels of reduced venous flow and muscular activity or loss of the flow-regulated transcription factors FOXC2 and PROX1 is sufficient to reverse this local anti-thrombotic phenotype and predispose toward peri-valvular venous thrombosis. Consistent with these experimental observations in mice, the peri-valvular endothelium at the site of human DVT exhibits identical loss of this unique transcription factor and anti-thrombotic phenotype. These studies provide a hemodynamic, cellular and molecular mechanism for DVT that explains its association with immobility and has immediate implications for the treatment of this common and lethal disease.

The first mechanism for DVT proposed by Virchow was “venous stasis” and the best-established clinical risk factor for DVT is immobility. Stasis has been defined as changes in venous blood flow that are associated with physical immobility, but why immobility should confer major changes in venous blood flow is not immediately apparent because blood flow in the large veins of the leg (where DVTs arise) is determined primarily by cardiac output and therefore remains at a high level even in an immobile individual. A clue to the mechanism by which mobility can alter DVT risk emerged in the 1960s and 1970s when autopsy studies revealed that even very large DVTs arise from small clots that form in the venous valve sinus. Venography of immobile individuals revealed slow exchange of blood in the valve sinus compared with the rest of the vein, suggesting that the valve sinus can be a particular site of hemodynamic stasis involved in clot formation and DVT. However, certain studies have identified a powerful anti-thrombotic phenotype among the endothelial cells lining the venous valve sinus, predicting that this region should be at lower risk for clot formation than the rest of the vein, and raising the question of why DVTs would form preferentially at that site. The disclosed subject matter resolves these important observations and support a mechanism in which muscular activity associated with physical mobility generates hemodynamic forces in the venous valve sinus that up-regulate expression of the FOXC2 and PROX1 transcription factors known to be activated by regular periods of OSS that in turn are required to maintain a strong anti-thrombotic and anti-inflammatory environment around the venous valve (FIG. 10A). Significant loss of this transcription factor and anti-thrombotic phenotypes was observed only 72 hours after reducing venous blood flow and muscular activity in mice, suggesting that they are highly dynamic and explaining how even relatively short periods of immobility can raise the clinical risk of DVT formation.

Virchow's second proposed mechanism for DVT pathogenesis was vessel wall injury. Since histologic studies have failed to demonstrate physical injury at the site of DVT formation, this mechanism has more recently come to be interpreted as vessel wall inflammation, but a molecular and/or cellular basis for such local inflammation has not been identified. The disclosed subject matter does not demonstrate the acquisition of an active inflammatory endothelial phenotype around the venous valve following loss of venous blood flow or endothelial FOXC2 or PROX1, but they do reveal loss of a strong peri-valvular anti-inflammatory endothelial phenotype characterized by the absence of surface P-selectin and ICAM1 expression, an inability to support leukocyte rolling, and a lack of vWF expression that is strongly protective against clot formation, namely DVT. The role of leukocytes in thrombus formation is well-established, and particularly important in venous thrombosis. Leukocytes express tissue factor required to activate clotting, as well as neutrophil extruded DNAs (NETS) that support clot formation. Venous thrombi form at much lower shear forces than arterial thrombi such as those responsible for myocardial infarction and stroke and incorporate large numbers of circulating white and red blood cells in addition to platelets. Thus, the disclosed subject matter also provides a molecular and cellular mechanism for the role of endothelial inflammatory responses connected to thrombosis during DVT formation.

The disclosed subject matter reveals a hemodynamic and transcriptional mechanism by which intravascular thrombosis is limited biochemically specifically within the venous valve sinus that is a site of common clinical thrombosis. Thrombin is the key regulator of clot formation in vivo because it both activates the cells involved in clot formation (e.g. platelets and leukocytes) via G-protein coupled thrombin receptors and cleaves circulating fibrinogen to create cross-linked fibrin. Co-expression of THBD and EPCR on the peri-valvular endothelial cell surface is predicted to create a highly anti-thrombotic local environment because thrombin bound to THBD efficiently activates protein C bound to EPCR, resulting in powerful negative feedback that ultimately turns off thrombin generation and prevents clot formation. When activated protein C generation can be combined with local TFPI expression to block the activity of cell-associated tissue factor (a key first step in thrombin generation), and there is concurrent loss of vWF expression required for efficient platelet recruitment, and the loss of P-selectin and ICAM1 required for efficient leukocyte recruitment, the result is a powerful, endothelial specific and synergistic molecular inhibition of thrombus formation at the venous valve, and this is facilitated by hemodynamic stimulation of FOXC2 and PROX1 expression.

The discovery of a specific hemodynamic requirement in the venous valve sinus to prevent loss of the peri-valvular anti-thrombotic phenotype has immediate implications for the clinical approaches to DVT among high-risk patients such as those in hospital. Prior treatments and prevention of DVT consists of systemic anti-coagulation and pneumatic compression devices designed to augment venous flow in the legs. Since many patients at the highest risk for DVT are also at high risk for hemorrhage due to recent surgery or trauma, systemic anticoagulation is often not tolerated. Pneumatic compression devices are widely prescribed to reduce the incidence of DVT in hospitalized patients, consistent with a hemodynamic mechanism, but these devices have been designed and applied without a clear understanding of precisely how to change venous hemodynamics to protect against DVT. Prior clinical devices were designed to create increased forward flow (venous flow to the heart) but without consideration to the role of flow patterns within the valve sinus specifically. It is likely that mechanical therapy could be significantly improved if it were designed specifically to re-establish certain oscillatory flow in the venous valve sinus required to maintain the anti-thrombotic endothelial phenotype and thereby prevent DVT. Thus, the creation of new mechanical therapies designed to specifically restore levels of oscillatory flow in the venous valve sinus is disclosed to improve the prevention of DVT in large numbers of at-risk individuals.

The present disclosure provides venous thromboembolism mitigation techniques. Muscular action drives both increased forward flow in veins, and also increased oscillatory, or reversing, flow specifically within the venous valve sinus where DVTs form. Furthermore, that this flow pattern was found to activate the expression of flow sensitive transcription factors specifically in the endothelial cells lining the valve sinus. These transcription factors, FOXC2, GATA2 and PROX1, then act to both block expression of several prothrombotic proteins and enhance the expression of several anti-thrombotic proteins. The net effect of this pathway is a synergistic, powerful anti-thrombotic phenotype in healthy venous valves. However, in mice when normal active flow patterns were altered, or flow-sensitive transcription factors were genetically deleted, this anti-thrombotic phenotype was lost, and the valve sinus became prothrombotic. These findings were supported by human autopsy results from patients who died of VTE in which there is loss of the anti-thrombotic endothelial phenotype specifically in the valve sinus that is the origin of DVT. These results also support that simply increasing venous blood return cannot protect against VTE, but that increasing venous valve oscillatory flow in immobilized patients can provide both a genetic and physical means to prevent clot formation.

The subject matter disclosed herein provides methods of preventing or mitigating VTE by, for example, generating oscillatory flow in the venous valve sinus of immobile persons through mechanical device designs selected to generate oscillatory flow in the venous valves of the leg where DVT formation originates to a similar extent as muscular action has been observed to. The term “mechanical” indicates a physical manipulation of a passive foot/ankle and applies to all methods of device actuation and function.

Despite its high prevalence and mortality, the molecular and genetic mechanisms that underlie DVT remain unknown. Each year approximately 900,000 individuals experience DVT, and 60-100,000 die due to DVT+PE in the US. The pathogenesis of DVT was first addressed by Virchow, who proposed immobility and reduced venous flow as the primary cause of DVT. Remarkably, with the exception of DVT due to rare genetic causes of hypercoagulability (such as Factor V Leiden and Factor IX Padua), the prior understanding of DVT pathogenesis remains epidemiologic and descriptive and lacks a specific molecular and cellular mechanism. The disclosed subject matter identified a molecular and cellular mechanism for DVT based on loss of a flow-regulated transcriptional pathway required to maintain an anticoagulant phenotype in peri-valvular venous endothelial cells. The present disclosure uses this new knowledge to prevent or mitigate DVT and PE by restoring levels of peri-valvular oscillatory flow by using a venous thromboembolism mitigation device.

Deep venous thrombosis (DVT) and secondary pulmonary embolism (PE) cause approximately 100,000 deaths per year in the US. Venous stasis associated with physical immobility has been identified as a primary risk factor for DVT since Virchow's observations in 1856, but a molecular and cellular basis for this link has not been defined. The endothelial cells surrounding the venous valve, where DVTs originate, experience oscillatory shear forces in response to muscular activity. Peri-valvular venous endothelial cells express high levels of FOXC2 and PROX1, transcription factors known to be activated by oscillatory shear stress, exhibit an anti-thrombotic phenotype characterized by low levels of the procoagulant proteins von Willebrands Factor (vWF), P-selectin and intercellular adhesion molecule 1 (ICAM1), high levels of the anticoagulant proteins thrombomodulin (THBD), endothelial protein C receptor (EPCR) and tissue factor pathway inhibitor (TFPI), and resistance to thrombin-induced clot formation. The peri-valvular venous anti-thrombotic endothelial phenotype is lost following femoral artery ligation that reduces venous flow or genetic loss of FOXC2 or PROX1 in mice, and at the site of human DVT associated with lethal PE. These findings provide a molecular and cellular explanation for clinical observations spanning a century and a half and support a mechanism in which DVTs form when reduced muscular activity results in loss of oscillatory shear-dependent transcriptional and ant-thrombotic phenotypes in peri-valvular venous endothelial cells.

Deep venous thrombosis (DVT) is a common vascular disease with an annual incidence of 0.1% among the general population, and >1% among hospitalized individuals. Pulmonary embolism (PE)—the blockade of pulmonary flow caused by a DVT that becomes dislodged and travels through the venous system to the lungs—is the third most common cause of cardiovascular death after myocardial infarction and stroke. Unlike myocardial infarction and stroke, DVT is not a thrombotic complication of atherosclerosis and present therapy is limited to systemic anticoagulation and mechanical compression devices designed to increase venous flow.

Thus, the focus for the presently-disclosed VTE mitigation is their ability to stimulate peri-valvular oscillatory flow in the immobile leg. In accordance with the disclosed subject matter, the foot is preferably compressed and dorsi-flexed rapidly and simultaneously to drive a venous flow wave like that stimulated by muscular contraction. This is one difference between presently-disclosed VTE mitigation devices and those that have been previously created and used. This strategy leverages molecular and cellular events, such as those, described herein and is consistent with and explain a body of data going back to 1856 that link immobility, the role the valve sinus and regulation of clotting in DVT.

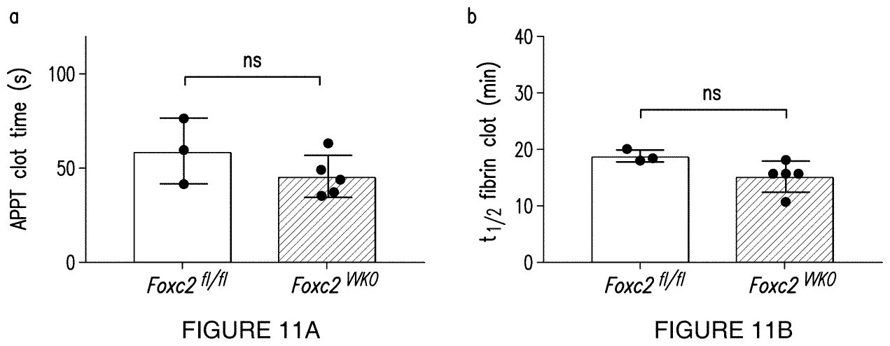

With reference to FIG. 11A for the purpose of illustration and not limitation, there is provided a graph illustrating quantification of mean activated partial thromboplastin time (APPT) for both Foxc2^{fl/fl} (white bars) and littermate Foxc2^{VKKO} mice (grey bars) is shown. This data demonstrates that the observed changes in thrombus formation in the venous valve sinus region is a result of endothelial changes rather than systemic changes to the coagulation profile of the animals as a result of an unappreciated effect of genetic manipulation of FOXC2 expression.

With reference to FIG. 11B for the purpose of illustration and not limitation, there is provided a graph illustrating quantification of the half-time of well-plate fibrin clot formation for both Foxc2^{fl/fl} (white bars) and littermate Foxc2^{VVKO} mice (grey bars) is shown. Error bars indicate standard deviation and significance was determined by unpaired, two-tailed t-test. ns indicates no significant difference. These data further support the lack of a systemic change in coagulability of the FOXC2 knockout mice and suggest that the observed changes in thrombosis is due to the identified anti-thrombotic gene program and not systemic changes to blood coagulability due to the genetic mutation.

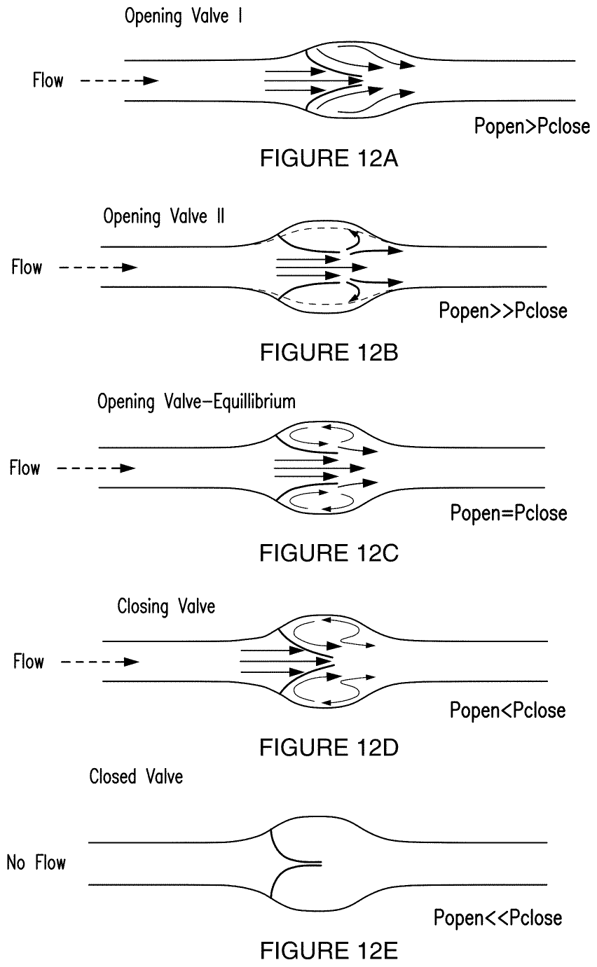

With reference to FIGS. 12A-12E for the purpose of illustration and not limitation, there is provided a schematic illustrating venous valve flow. Physiological venous flow is driven by changes in pressure that drive valve opening and closing. Physical movement and leg muscle contraction are not necessary to drive venous flow but are necessary to drive valve sinus reversing flow (FIGS. 12A-C). With reference to FIGS. 12A and 12B for the purpose of illustration and not limitation, the schematic illustrates the opening of valves I and II, respectfully, when Pₒₚₑₙ is than greater P_{close} and when Pₒₚₑₙ is much greater than P_{close}, respectfully. With reference to FIG. 12C for the purpose of illustration and not limitation, the schematic illustrates that the opening of both valves I and II leads to an equilibrium when Pₒₚₑₙ is P equal to P_{close}. With reference to FIG. 12D for the purpose of illustration and not limitation, the schematic illustrates the closing of valve II, when Pₒₚₑₙ is less than P_{close}. With reference to FIG. 12E for the purpose of illustration and not limitation, the schematic illustrates no flow when Pₒₚₑₙ is much less than P_{close}.

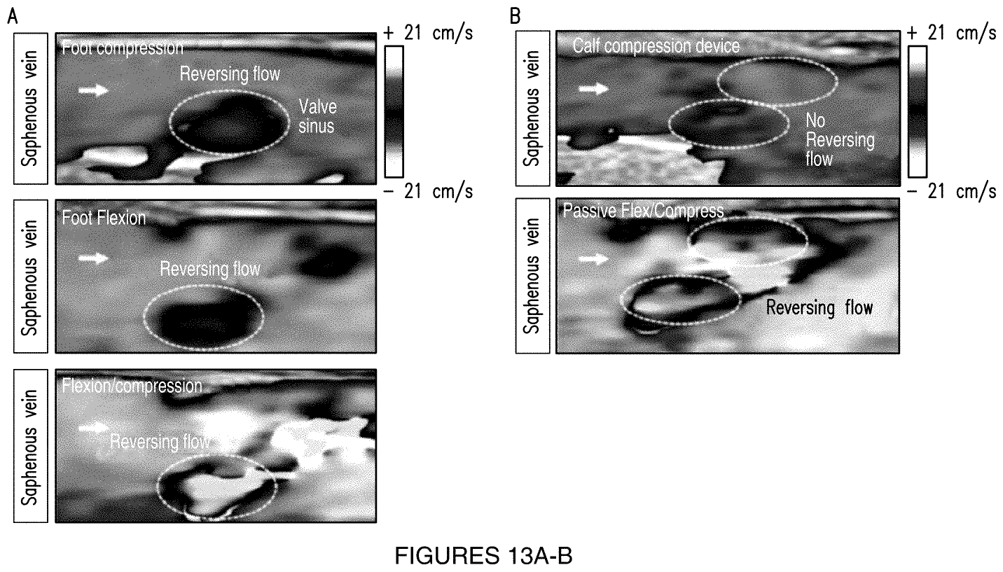

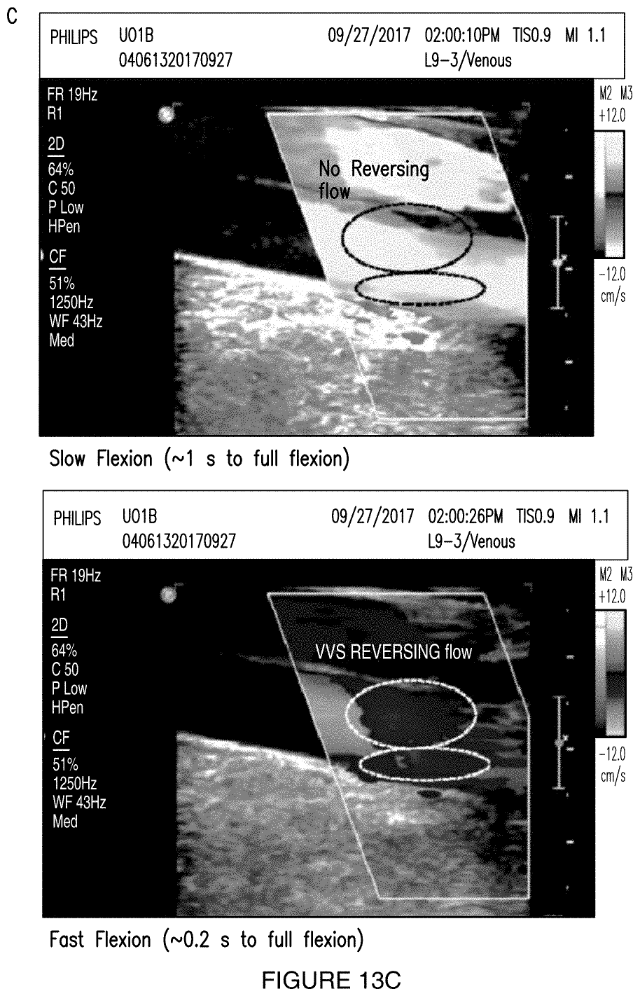

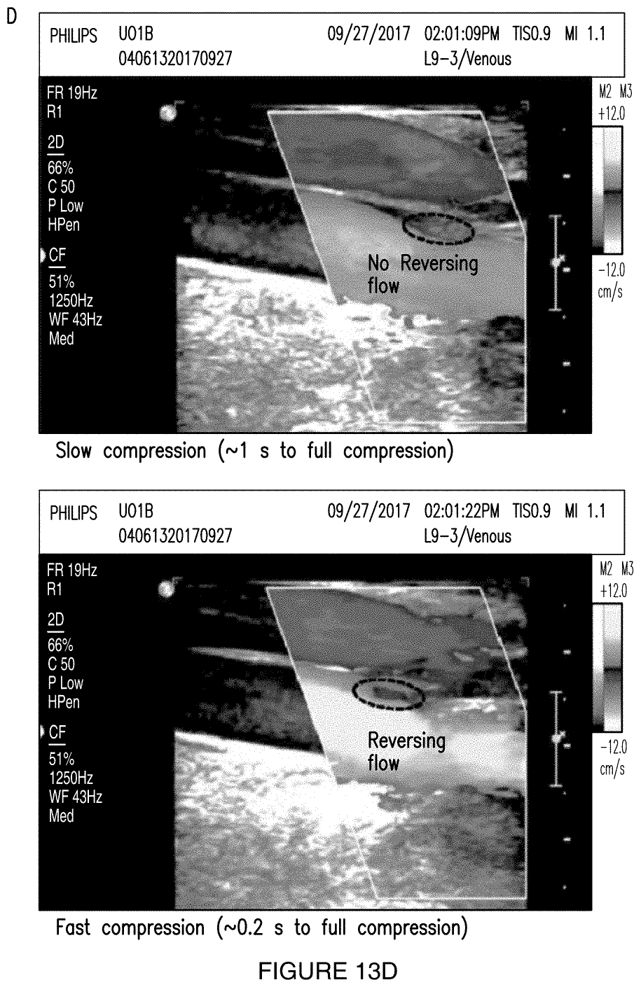

With reference to FIGS. 13A-13D for the purpose of illustration and not limitation, there is provided a schematic illustrating ultrasound imaging of flow at the saphenous vein valve in humans can be used to easily assess flow conditions at venous valves and can be used to determine optimal actions and timing of actuations to increase valve sinus reversing flow. (FIG. 13A) A representative image of 2D color Doppler ultrasound was used to monitor flow in the venous valve sinus in the saphenous vein of a human subject during foot flexion alone (top), foot compression alone (middle), and flexion and compression simultaneously (bottom). An arrow indicates the direction of centerline flow, and the valve sinus is shown with a dotted white line. The extent of reversing flow is shown with increasing bright signal within the valve sinus. (FIG. 13B) Representative images of venous valve sinus flow during use of a calf compression bladder (ArjoHuntleigh single bladder ICD) (top) and during simultaneous foot flexion and compression (bottom) in the same volunteer. An arrow indicates the direction of centerline flow, and the valve sinus is indicated with a dotted white line. The presence of reversing flow is shown by altered coloration in the valve sinus and indicated with a label. (FIG. 13C) A representative image of 2D color Doppler ultrasound in the common femoral vein of a human subject during manual flexion of the subject's foot applied either over 1 second to full flexion (left) or over 0.2 seconds (right). The valve sinus is shown with a dotted line (either white or black), and the amount of reversing flow is shown with altered colors in the sinus and indicated with a label. (FIG. 13D) A representative image of 2D color Doppler ultrasound in the common femoral vein of a human subject during manual compression of the subject's foot applied either over 1 second to full compression (left) or over 0.2 seconds (right). The valve sinus is shown with a dotted line, and the amount of reversing flow is shown with altered colors in the sinus and indicated with a label. These images are representative of at least five (5) subjects. These findings demonstrate the additive value of a simultaneous foot compression and foot flexion, as both manipulations actuate different pools of venous blood increasing the level of recirculatory flow in venous valve sinuses away from the site of manipulation and in clinically relevant sites for DVT formation (saphenous and femoral veins). Further, they show how prior art devices designed to increase forward venous flow alone do not create valve sinus reversing flow. Finally, these data demonstrate the importance of the timing of the foot flexion/compression actuation in generating robust venous valve sinus recirculatory/reversing flow patterns, and that there is a distinct benefit of the mechanical action to occur well below 1 second.

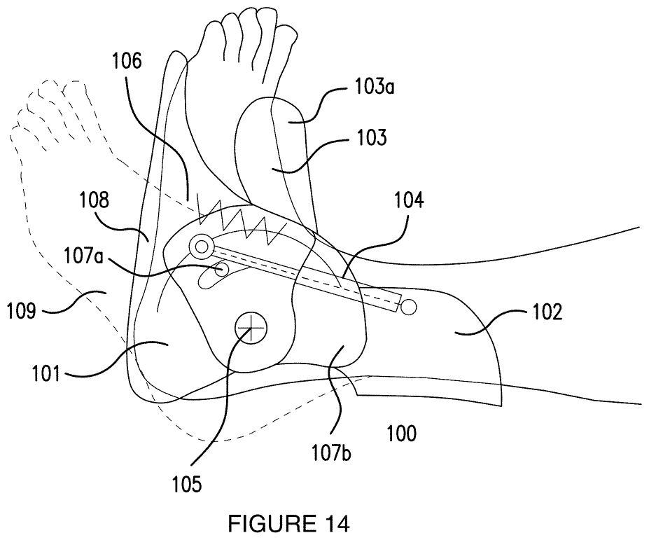

With reference to FIG. 14 for the purpose of illustration and not limitation, there is provided a schematic illustrating an exemplary VTE mitigation device 100. The device 100 includes a foot holster 101, ankle brace 102, and compression holder 103. The foot flexion is driven by the mechanical action of the actuator 104. This drives foot flexion towards the patient's head while in a prone position, activating calf tightening, and pushing the foot into the compression holder 103 to drive blood out of the foot 109. The compression holder can include any type of padding or compressible material such as foams, gel padding, air-filled padding and the like. FIG. 14 also includes a frame pivot 105, compression spring 106, limit screws 107a and 107b and a flexion pad or foot plate 108. The compression spring 106 preferably provides a preset amount of compressive force that can be modified by changing the spring properties and achieving a minimum compressive force of 100 mmHg. The extent of compression can also be controlled by any material that provides a progressive degree of resistance including springs, elastic bands and the like, that connects the top plate (or top part) 103a and the compression holder 103 to the foot holster 101.

FIG. 14 also illustrates foot position 109 represented by dotted lines, showing the foot in the un-flexed position of the device. The parts can be connected by nuts and bolts. The foot holster 101 is preferably configured to rotate in response to actuator 104. The top part (or top plate) 103a of the compression holder 103 also rotates when the foot is pressed into it to allow for foot flexion to be achieved, and simultaneous compressive forces are applied by tension in the compression spring 106.

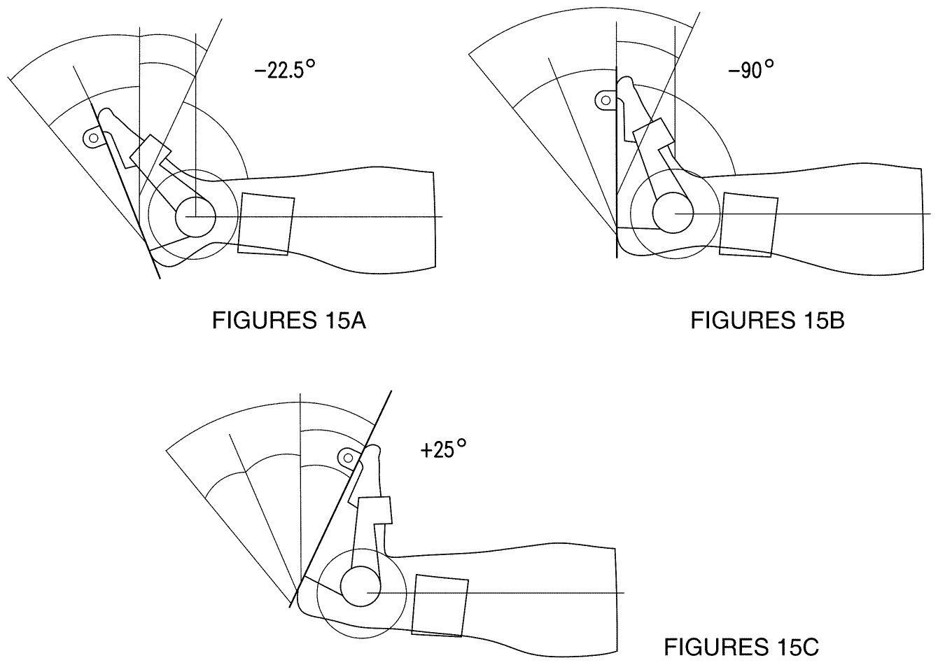

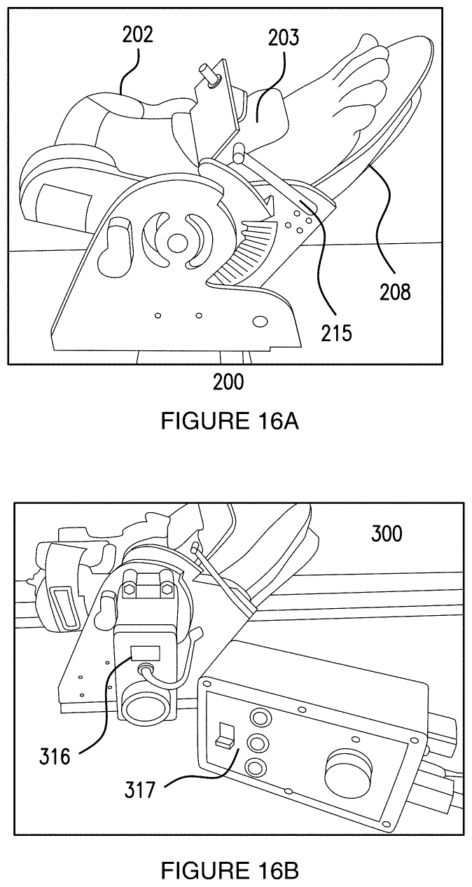

With reference to FIG. 15A for the purpose of illustration and not limitation, there is provided a schematic illustrating a plantarflexion or downward movement of the foot of about −25 degrees from the standing position of the foot. With reference to FIG. 15B for the purpose of illustration and not limitation, there is provided a schematic illustrating a neutral position, wherein the foot is about 90 degrees (from the surface the subject is laying on) from the standing position of the foot. With reference to FIG. 15C for the purpose of illustration and not limitation, there is provided a schematic illustrating dorsiflexion or upward movement of the foot of about +25 degrees from the standing position of the foot.

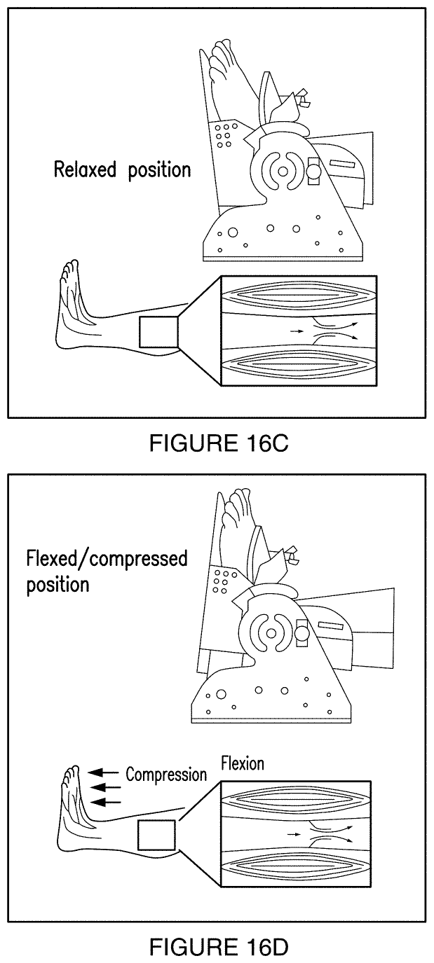

With reference to FIGS. 16A-16D for the purpose of illustration and not limitation, there is provided a schematic illustrating exemplary VTE mitigation devices to drive oscillatory flow in the venous valve sinuses of the leg. For the purpose of illustration and not limitation, FIG. 16A provides a schematic illustrating exemplary mechanical VTE mitigation device 200, showing ankle support 202, compression holder 203, pivoting foot plate or flexion pad 208 and compression spring 215. The ankle support is a soft fabric or padded strap that goes across the ankle and is tightened to fit the ankle of the individual wearing the device. This design and material allows for a tight but comfortable fit to maintain foot flexion during actuation without allowing for foot movement out of the foot holster or the calf to raise out of the device, but maintain a comfortable user experience. The compression holder is positioned to move partially with the flexion action of the foot plate so as not to obstruct the foot flexion action. The holder is positioned to stop flex to an angle 5 degrees less than the flexion as the foot plate. This drives the foot into the padding on the compression plate during the final degrees of motion to provide a padded surface for the foot to flex into during full flexion to provide comfortable compression of the foot to drive blood out of the plantar venous plexus. Dorsiflexion of the foot is accompanied by compression at the top of the foot. The extent of flexion can be controlled, e.g., by limit screws (not shown in FIG. 16A) that physically block foot plate flexion beyond the set position, and the extent of compression by the spring(s) 215 that connect to the top plate 203a and compression holder 203 (foam) to the rotating unit.

For the purpose of illustration and not limitation, FIG. 16B provides a photo of an exemplary motorized VTE mitigation device 300 showing actuating motor 316 and the motor controller 317. The motor controller regulates the motor power which impacts the speed of the flexion plate motion.

For the purpose of illustration and not limitation, FIG. 16C provides a schematic depicting blood flow around a venous valve of the leg when the VTE mitigation device is in the relaxed position, while FIG. 16D provides a schematic depicting oscillatory or reversing blood flow around a venous valve of the leg when the VTE mitigation device is in the flexed/compressed positions.

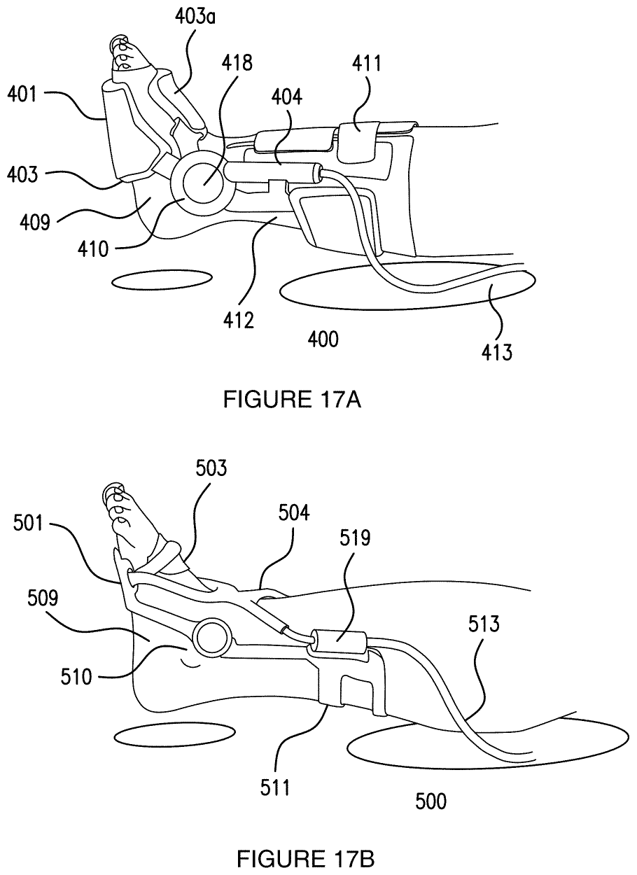

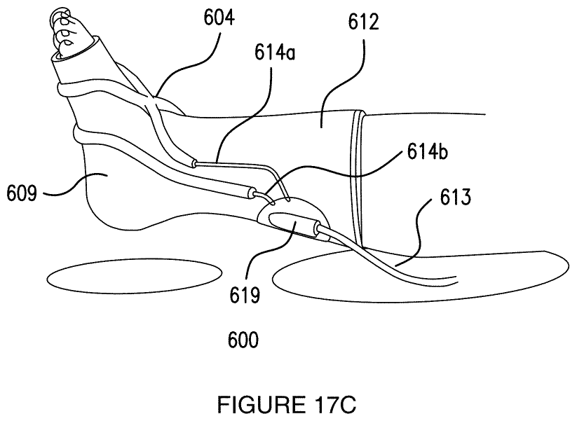

With reference to FIGS. 17A-C for the purpose of illustration and not limitation, there is provided a schematic illustrating exemplary devices with pneumatic actuation, electric, or hydraulic actuation.

With reference to FIG. 17A for the purpose of illustration and not limitation, there is provided a schematic illustrating an exemplary VTE mitigation device 400. The device 400 includes a foot holster 401 that can be made of a semi-rigid plastic cover or other materials and containing compressible padding 403. The foot flexion is driven by the hydraulic, pneumatic or electric drive piston 404. This drives foot flexion towards the patient's head while in a prone position, activating calf tightening, and pushing the foot into the cushioning 403 to drive blood out of the foot 409. FIG. 17A also includes a disc cover 410, elastic sock 412, Velcro fastening straps 411 for securing the elastic sock and a fluid/air or power line 413. This device 400 will function by pneumatic/hydraulic pressure being applied through fluid/air power line 413 driving piston action in drive piston 404, and rotating foot holster 401, containing padding 403, at the pivot point 418. The top plate 403a that contains compressible padding 403 is not actuated, and flexes as the foot 409 is pressed into it but has a tension that resists flexion providing compression. The elastic sock 412 is secured with Velcro, the frame is attached to the sock with stitching. Cushioning 403 is adhered to foot holster 401. Foot holster 401 is welded/screwed to pivot point 418 in 410 housing. Top plate 403a is attached to rotating foot holster 401 with springs or other tension-creating material within disc cover 410's housing.

With reference to FIG. 17B for the purpose of illustration and not limitation, there is provided a schematic illustrating an exemplary VTE mitigation device 500. The device includes an air muscle 519 connected to air line 513. FIG. 17B also includes a foot holster 501 that can be made of a semi-rigid plastic cover or other materials and a top plate 503 that can secure the foot to the foot holster 501. This device 500 will function by function by pneumatic/hydraulic pressure being applied through the air line 513 to inflate the air muscle 519. Inflation of the air muscle 519 inflates and shortens the length of the tubing 604, thereby pulling the foot toward the head at the pivot point 510, and inflates the tubing 504 that presses on the foot 509.

With reference to FIG. 17C for the purpose of illustration and not limitation, there is provided a schematic illustrating an exemplary VTE mitigation device 600. The device 600 includes an air muscle 619 connected to air line 613 by connectors 614a and 614b. FIG. 17C also includes a soft elastic sock 612, which provides a connection point for the tubing to be stabilized in space during patient use and helps disperse the compressive force. This device 600 functions similarly to FIG. 17B where inflation of the air muscle 619 shortens the length of the tubing (air muscle) pulling the foot towards the head and inflates the tubing 604 that presses on the foot 609. The air muscle 619 attached to elastic sock 612 in FIG. 17C can be attached with stitching and adhesives.

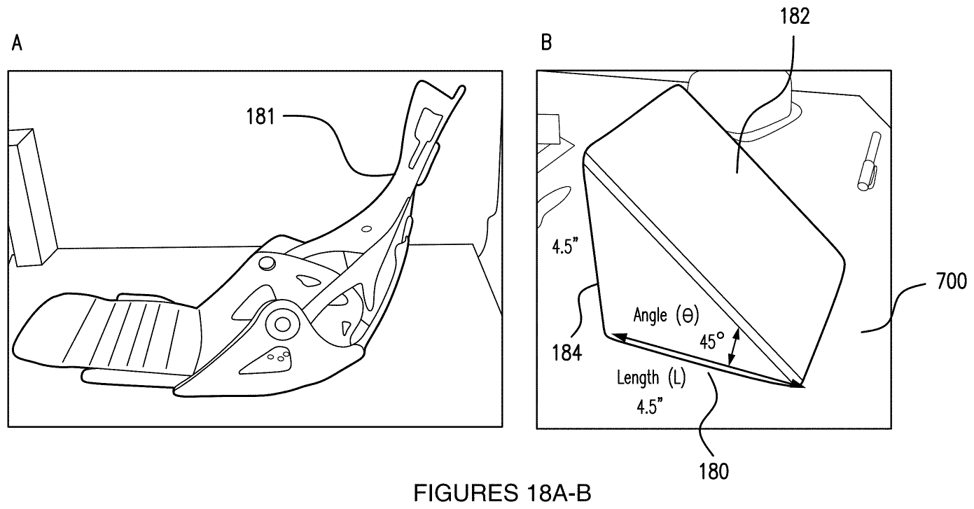

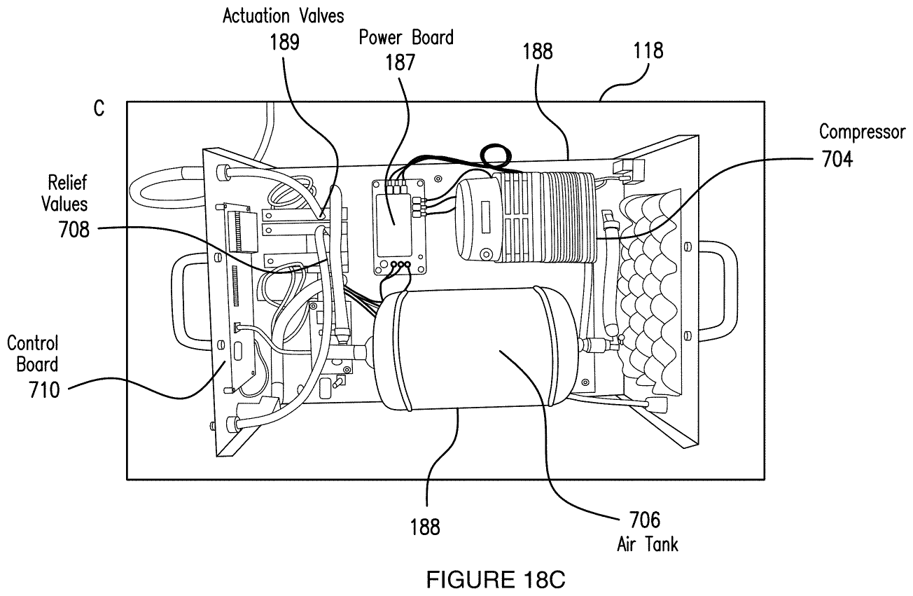

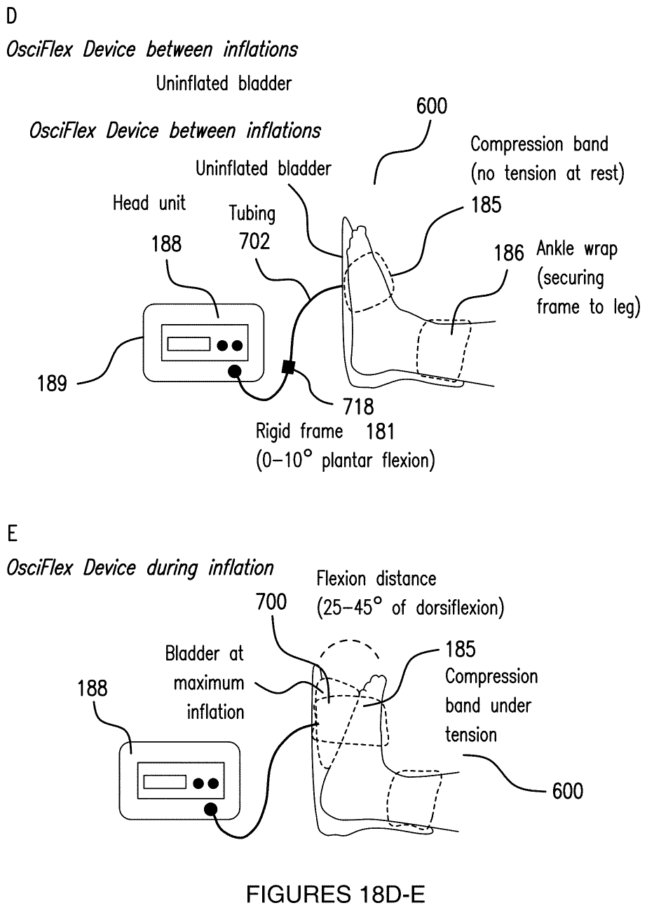

With reference to FIGS. 18A-18G for the purpose of illustration and not limitation, there is provided a schematic illustrating an exemplary VTE mitigation device.

With reference to FIG. 18A for the purpose of illustration and not limitation, there is provided a schematic illustrating an exemplary wearable boot. The wearable boot can include a rigid plastic frame 712. The rigid plastic frame 712 can attach to a foot of the immobile person and extend to the ankle of the immobile person. In some embodiments, the rigid plastic frame 712 can be covered in fabric and padding to maximize user comfort.

With reference to FIG. 18B for the purpose of illustration and not limitation, there is provided a schematic illustrating an exemplary inflation bladder 700. The inflation bladder 700 can inflate and deflate such that simultaneous rapid flexion and compression induced by the inflation bladder 700 induces the venous valve oscillatory flow to preserve the natural mechanism of DVT prevention associated with muscular activity. In some embodiments, the inflation bladder 700 can be wedge-shaped. In some embodiments, the inflation bladder is adapted to be deflated to about 10 mmHg such that the inflation bladder can be re-inflated more rapidly and with less noise generation but does not create any measurable foot flexion. The inflation bladder can be smoothly re-inflated to ensure uniform inflation. In some embodiments, the inflation bladder has a base face 180 with length of approximately 4.5 inches and a forward face 184 having a length of approximately 4.5 inches. Preferably, when fully inflated a top face 182 of the inflation bladder forms an angle of approximately 45 degrees with the base face 180.

With reference to FIG. 18C for the purpose of illustration and not limitation, there is provided a schematic illustrating an exemplary head unit 188. The head unit 188 is pneumatically coupled to the inflation bladder 700 via a ⅜ inch inner diameter tube 702 that allows sufficient air volume flow to the bladder 700 to support the designated inflation times. The head unit 188 can have an air compressor 704 and a compressed air tank 706. The air compressor 704 can be pneumatically coupled to the compressed air tank 706 and fill the compressed air tank 706 with compressed air to a pre-determined pressure set and monitored by the electronic controller. The compressed air tank 706 can then release the compressed air, by opening solenoid valves built into the head unit 188 and controlled by the electronic controllers within the head unit 188, to the inflation bladder 700 to drive inflation thereof via the tube 702. The release of air can be regulated by the opening and closing of the solenoid valves. The frequency and duration of the opening of the valve can be programmed into a printed circuit board (PCB) controller within the head unit 188 and set using user interface controls. In some aspects, the head unit 188 includes an LED screen user interface. The controller can control the head unit 188 to trigger inflation and foot actuation with bursts of air that preferably inflate the inflation bladder 700. The bursts of air are preferably from about 200 milliseconds to about 300 milliseconds long. As the compressed air tank 706 releases compressed air, the inflation bladder 700 can inflate. When the compressed air tank 706 stops releasing compressed air, the inflation bladder 700 can deflate through a pressure release valve, preferably disposed within the head unit 188. The compression band provides a decompressive force to facilitate the rapid complete deflation of the bladder by the weight of the foot and compression forces. The compressed air tank 706 can repeatedly inflate and deflate the inflation bladder 700 such that motion of the inflation bladder 700 causes foot movement to induce the venous valve oscillatory flow in the leg veins of the immobile person to preserve the natural mechanism of DVT prevention associated with muscular activity. The actuation bursts preferably have a minimum intervening dwell time configured to restore venous pressures to pre-actuation levels. Preferably, the intervening dwell time is about 10 seconds. In some embodiments, the intervening dwell time is greater than 10 seconds. In some embodiments, the intervening dwell time is greater than 5 seconds. In some embodiments, the intervening dwell time is about 1 minute. The intervening dwell time can allow the physical actuation to drive the same amount of venous return in response to actuation. When venous pressure is depleted further actuations result in decreasing flow and limited reversing flow in the valve sinus rendering the device less effective. The controller can be coupled to the foot support and can be configured to induce the periodic dorsiflexion and increased compression in a predetermined time cycle. The predetermined time cycle can include a plurality of dorsiflexion time periods, wherein each dorsiflexion time period is followed by a intervening dwell time. In an embodiment, the dorsiflexion time period is between 0.1 seconds and 0.5 seconds and the intervening dwell time is at least 10 seconds. In aspects of the invention the dorsiflexion time period is less than 0.5 seconds, less than 0.4 seconds, less than 0.3 seconds or less than 0.2 seconds.

In some embodiments, the head unit 188 can include a solenoid valve 718. The solenoid valve 718 can be placed along the tube 702 connecting compressed air tank 706 and the inflation bladder 700 and can regulate the release of the compressed air from the compressed air tank 706 to the inflation bladder 700 by opening and closing. In some embodiments, the head unit 188 can include at least one pressure sensor 189. The at least one pressure sensor 189 can monitor air pressure of the compressed air tank 706 and direct the air compressor 704 to restore the air pressure to the pre-determined level. In some embodiments, the head unit 188 can include at least one pressure relief valve 708. The pressure relief valve 708 can monitor air pressure of the inflation bladder 700 and relieve air pressure to prevent over-inflation thereof. In some embodiments, the head unit 188 can include a control board 710. The control board 710 can be electrically coupled to the air compressor 704 such that the control board 710 initiates inflation of the inflation bladder and to control parameters of inflation. The head unit 188 can include a power board 187. The power board 187 can be configured to provide power to compressor 704, control board 710, and pressure sensor 189. In an embodiment, power board 187 receives power from an external source. In another embodiment, power board 187 receives power from an internal source, such as a battery contained within head unit 188. The head unit 188 can include an external casing 189 that can be designed to limit creases and ridges to allow for efficient sterilization.

With reference to FIG. 18D for the purpose of illustration and not limitation, there is provided a schematic illustrating an exemplary VTE mitigation device 600. A rigid frame 181 of VTE mitigation device 600 can be attached to the foot of the immobile person and extend to (or slightly above) the ankle of the immobile person. An ankle wrap 186 can secure the rigid frame 181 to the leg of the immobile person and a compression band 185 can secure the rigid frame to the foot of the immobile person. The rigid frame 181 can include an inflation bladder 700 disposed between the rigid frame 181 and the foot. Tubing 702 can pneumatically couple the inflation bladder 700 to a head unit 188. The tubing connection can be located on the bottom or the side of the bladder thereby preventing disruption of the bladder during inflation and deflation. The inflation bladder 700 can inflate and deflate such that simultaneous rapid flexion and compression induced by the inflation bladder 700 induces the venous valve oscillatory flow to preserve the natural mechanism of DVT prevention associated with muscular activity. For example, the inflation bladder is configured to cause 25° to 50° of dorsiflexion, beyond a neutral 90° position, at maximum inflation. In some embodiments, the inflation bladder is configured to cause approximately 45° of dorsiflexion, beyond a neutral 90° position. In some embodiments the inflation bladder is configured to cause 25° to 45° of dorsiflexion, beyond a neutral 90° position, 30° to 40° of dorsiflexion, beyond a neutral 90° position, or about 30° of dorsiflexion, beyond a neutral 90° position.

FIG. 18D further illustrates an exemplary VTE mitigation device during the dwell period. The dwell period can be characterized by the inflation bladder being uninflated or inflated to a low threshold inflation (e.g., about 10 mmHg). During the dwell period illustrated in FIG. 18D, the compression band 185 can have no tension during the dwell period. In some embodiment, during the dwell period, compression band 185 have a low level of tension that, in some instances, permits the compression band to be retained in a selected position relative to the patient's foot.

FIG. 18E illustrates an exemplary VTE mitigation device 600 during a dorsiflexion period. In the illustrated embodiment, inflation bladder 180 has been inflated to a maximum inflation level which has induced a dorsiflextion of a selected value from 25° to 45°. The compression band 185 in FIG. 18E is under tension. The tension of the compression band 185 during the dorsiflexion period is configured to induce blood flow from the patient's foot. Preferably, the compression band 185 is configured to apply at least 100 mmHg of pressure to the patient's foot during dorsiflexion. In one embodiment, as inflation bladder inflates, the tension in the compression band 185 increases. In some aspects the increase in tension is a linear increase in tension through the dorsiflexion period. FIG. 18 E further illustrates the position of inflation bladder 130 to substantially act on the ball of patient's foot. Preferably, inflation bladder 130 extends proximally to the patient's heel pad but does not extend under the heel. Inflation bladder 130 preferably extends distally to the patient's phalanges

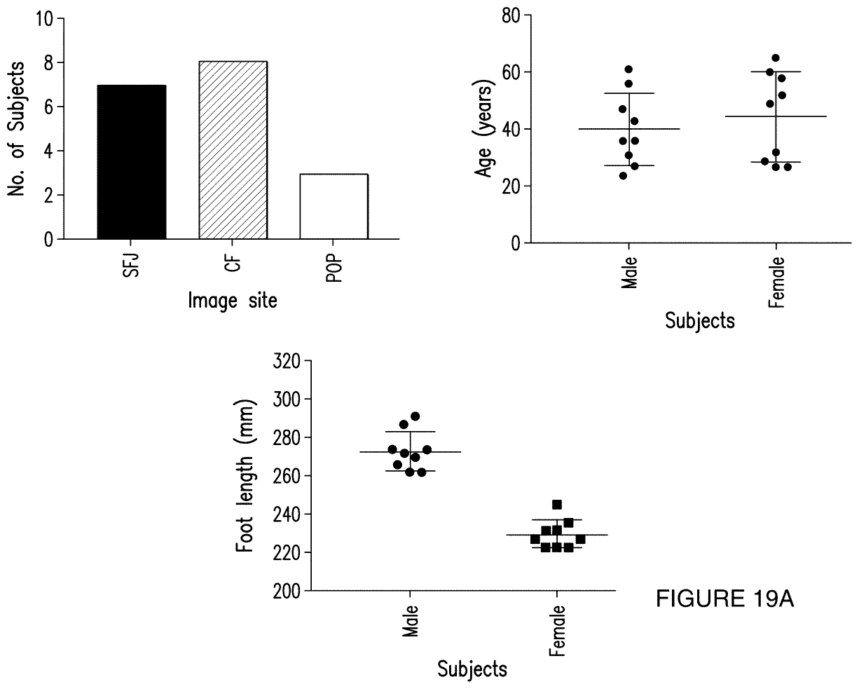

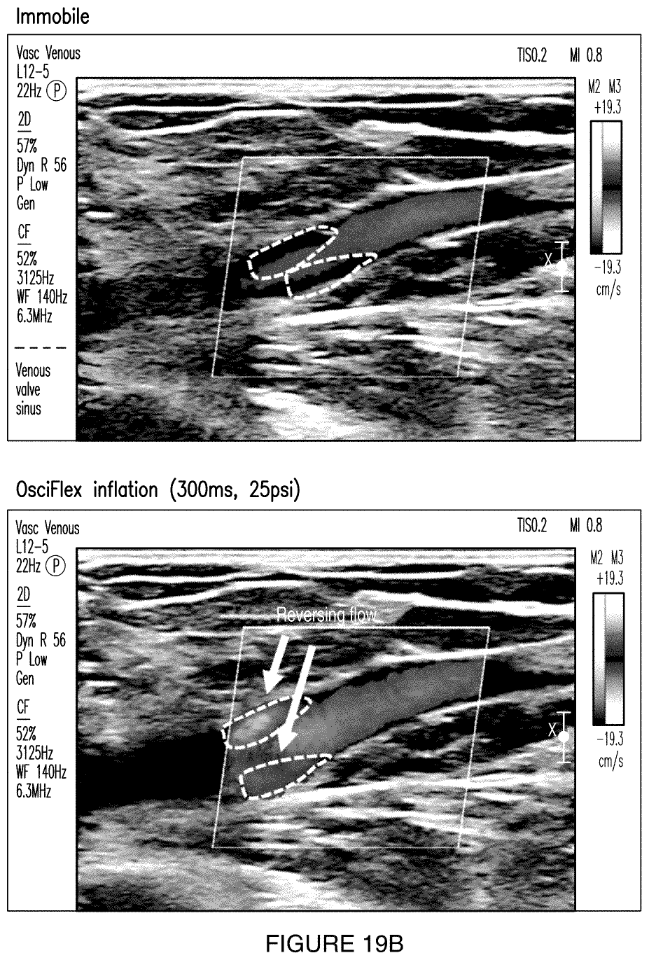

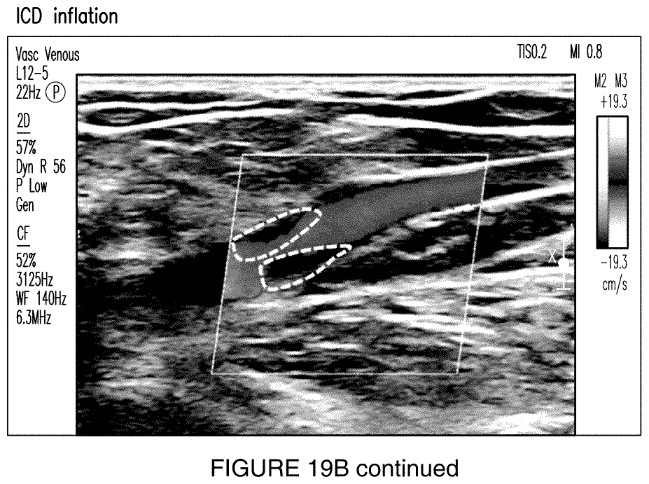

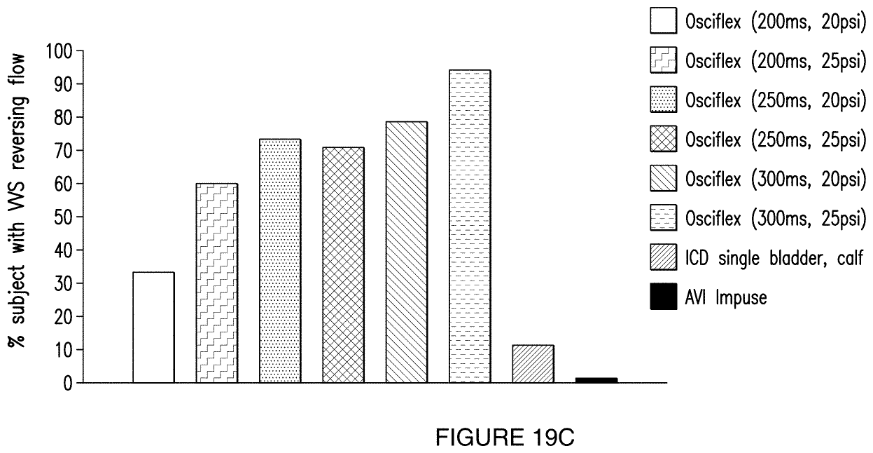

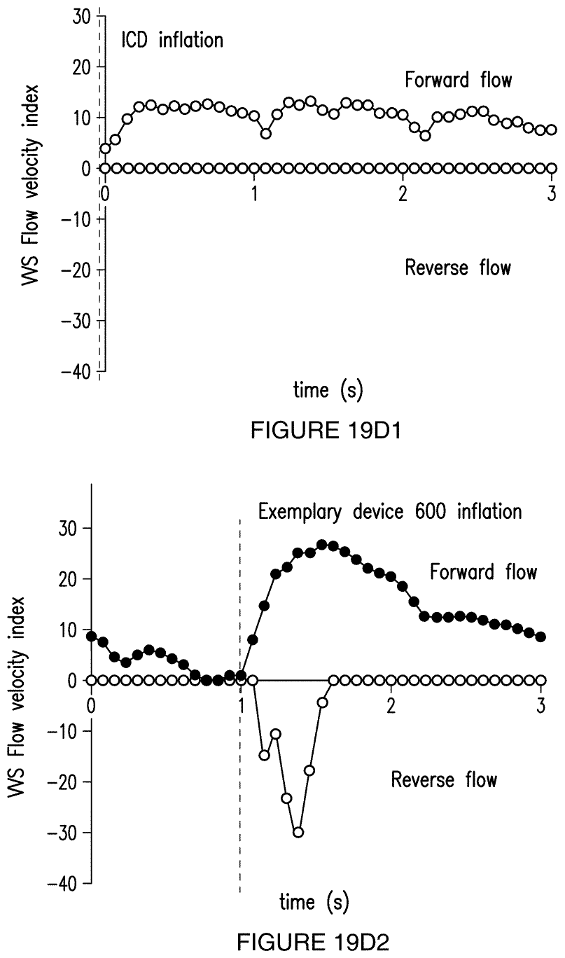

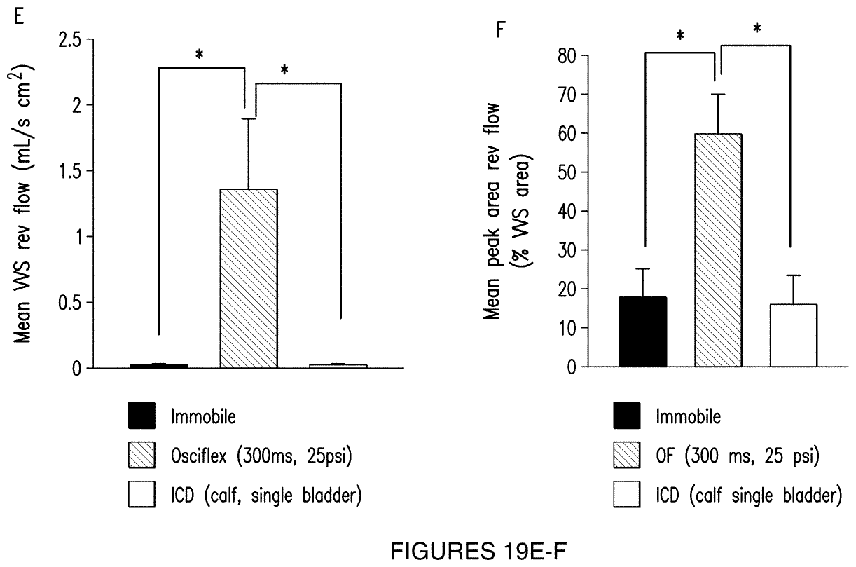

With reference to FIGS. 19A-19F for the purpose of illustration and not limitation, there is provided a schematic illustrating hemodynamic conditions at venous valves in healthy human subjects. With reference to FIG. 19A for the purpose of illustration and not limitation, there is provided graphs illustrating the anatomical site, age, and foot length for the subjects. Imaging was performed at one of three (3) sites (SFJ, sapheno-femoral junction; CF, common femoral; or POP, popliteal) based on the ability to visualize a valve at each site. The recruited subjects varied in ages from 23-64 years of age. The subject foot sizes also varied from 220 mm to 300 mm. The imaging sites are all clinically significant sites where DVTs form and are the most proximal sites that valves can be reliably imaged. This data demonstrates that the hemodynamic effects of the exemplary device is consistent across a broad range of ages and foot sizes.

With reference to FIG. 19B for the purpose of illustration and not limitation, there is provided a schematic illustrating 2D Doppler ultrasound of venous flow at a healthy venous valve. Venous return to the heart and reversing flow are shown. During immobility the venous valve sinus has little flow, shown by a lack of venous return to the heart. During inflation of the exemplary device illustrated in FIG. 18A-18E, a burst of flow (e.g, 300 ms at an inflation pressure of 25 psi) increases the venous return within the vein and creates strong reversing flow within the sinus. Inflation of a single bladder calf compression device (Arjo-Huntleigh Flowtron) illustrated in the image of FIG. 19B increases venous return through the vein indicated by increased signal intensity in the bulk of the vessel but does not increase valve sinus recirculation in the sinus.

With reference to FIG. 19C for the purpose of illustration and not limitation, there is provided a graph illustrating the presence of induced VVS recirculation as a percentage of the number of subjects imaged. 2D Color Doppler ultrasound was used to identify venous valve sinus (VVS) reversing flow with various levels of tank pressure (psi) and inflation times (ms) from the exemplary device illustrated in FIG. 18A-18E. Alterations of the inflation time altered both the speed of actuation as well as the extent of foot flexion by increasing the time of air flow into the bladder. Altering the tank pressure changed the amount of flexion over the same time period by increasing the flow of air from the tank to the bladder during the inflation time. The presence of induced VVS recirculation as a percentage of the number of subjects imaged was compared to both a calf ICD device (Arjo-Huntleigh Flowtron) and a foot pump device (AV Impulse). 300 ms of inflation at a tank pressure of 25 psi gave reversing flow in >90% of subjects. Studies using 400 ms inflation times did not show increasing benefits beyond 200 ms of inflation at a tank pressure of 20 psi, for example, compared to 300 ms inflation times. (data not shown). These results suggested that increasing flexion and actuation times of less than 0.5 seconds increased specifically the extent of venous valve recirculatory flow. In a preferred embodiment, acceptable reversing flow is obtained by using a bladder with about 45° of dorsiflexion beyond a neutral 90° position. Flexion beyond 45° of dorsiflexion beyond a neutral 90° position caused physical resistance in the ankle of some subjects, as it was past their maximal ankle flexion position. This resistance could cause discomfort and there is no additional hemodynamic benefit. Without being limited by theory, these findings illustrate conditions to drive venous valve recirculatory flow that will protect against diminishment of the protective endothelial genetic program and provide comfort for the subject wearing the device.

With reference to FIGS. 19D1 and 19D2 for the purpose of illustration and not limitation, there are provided graphs illustrating representative data from a single human subject quantifying the flow in the venous valve sinus (VVS) measured by 2D Color Doppler. Venous return to the heart and reversing flow are shown. The timing of initiation of inflation of either the ICD or exemplary device illustrated in FIG. 18A-18E are shown with a dashed black line. The exemplary device corresponding to the depicted flow graphs was inflated for 300 ms and the tank pressure was at 25 psi. The Flow Velocity Index of forward and reversing flow within the valve sinus was measured by quantifying the intensity of the blue (forward) and red (reversing) pixels within the valve sinus region from the 2D color Doppler recording. The intensity of the pixels is displayed in arbitrary units from 0-100 by the Doppler imaging and is correlated to the flow. The average velocity in both directions is then calculated and reported as the Flow Index for each time interval during the recording period. The data in FIG. 19D2 was generated using device 600 shown in FIGS. 18A-18E.

With reference to FIG. 19E for the purpose of illustration and not limitation, there is provided a graph illustrating the mean reversing flow in the venous valve sinus (VVS) measured by 2D Color Doppler. The flow was calculated by measuring the velocity of the reversing flow reported by Doppler and the area of reversing flow measured by Doppler within the valve sinus region determined from the physiological image of the vein in the grayscale ultrasound images. Multiplying the velocity values by the area provides the flow measurement in units of mL/s·cm² of vessel.

With reference to FIG. 19F for the purpose of illustration and not limitation, there is provided a graph illustrating the mean area of reversing flow within the venous valve sinus as calculated by measuring the area of the entire venous valve sinus and determining the area that show reversing flow during the peak flow generated by the inflation of each device tested. The resulting values are reported as a percent of the total area of the valve sinus. The areas of reversing flow in the venous valve sinus (VVS) were measured during subject immobility, OF inflation, or ICD inflation. The error bars show the standard error (n=11 subjects, * p-value<0.05).

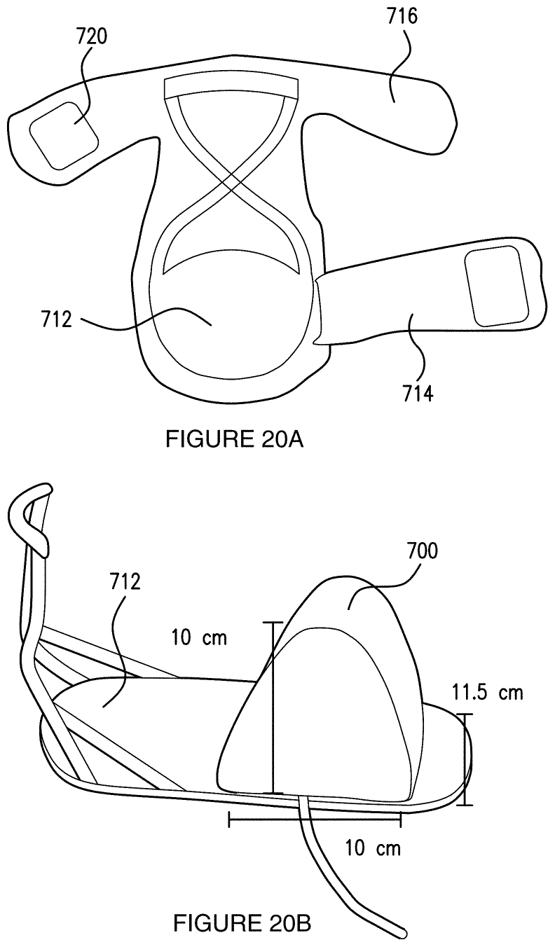

With reference to FIG. 20A for the purpose of illustration and not limitation, there is provided a schematic illustrating an exemplary VTE mitigation device. The inflation bladder 700 can be disposed within a wearable boot 712. In some embodiments, the inflation bladder 700 can be a horizontal semi-cylinder such that a flat side of the inflation bladder 700 is adapted to lie on a foot plate of the wearable boot 712 or a full cylinder such that the inflation bladder 700 lays horizontally across a foot plate of the wearable boot 712. The inflation bladder 700 is adapted to drive foot flexion to 20-45 degrees of dorsiflexion beyond a neutral 90 degree foot position when supine.

With reference to FIG. 20B for the purpose of illustration and not limitation, there is provided a schematic illustrating an exemplary wearable boot. The wearable boot can include a rigid plastic frame 712 and a compression band 714. The compression band 714 is sized and fit so as to cover the metatarsal region of the foot but not to extend substantially beyond the metatarsal in the proximal direction. This focuses the compression on the plantar region of the foot where the venous plexus is located to create the compression force that drives the increased venous return. Further, the compression band position is away from the ankle and will not provide discomfort during ankle rotation during flexion. The rigid plastic frame 712 can attach to a foot of the immobile person and extend to the ankle of the immobile person. The compression band can secure the foot of the immobile person to the rigid plastic frame 712. In some embodiments, the rigid plastic frame 712 can be covered in fabric and padding 718 to maximize user comfort. In some embodiments, the compression band 714 can use a loop and hook material 718, where two sides are pressed together so hooks can engage loops, to secure the foot of the immobile person to the rigid plastic frame 712.

Non-limiting example of embodiments of the present invention include the following:

(1) A device for mitigating thromboembolism in a patient, the device comprising a foot support assembly including a dorsiflexion inducing member configured to periodically urge a foot of the patient into dorsiflexion and a compression member configured to increase compression on a portion of the foot during the periodic dorsiflexion.

(2) The device of (1) wherein the periodic dorsiflexion and compression is configured to induce venous valve oscillatory flow in a leg of the patient.

(3) The device of (1) wherein the periodic dorsiflexion and compression is configured to induce venous oscillatory shear stress a leg of the patient.

(4) The device of (1) wherein the device is configure to place the patient's foot in an at rest position, wherein the dorsiflexion inducing member is engaged with a ball of the foot while the foot is in plantarflexion and the compression member provides a minimum level of pressure to the foot, and a dorsiflexed position, wherein the dorsiflexion inducing member applies pressure to the ball of the foot in a dorsiflexed position and the compression member provides a maximum level of pressure to the foot that exceeds the minimum level of pressure.

(5) The device of (1) further comprising a controller coupled to the foot support assembly, configured to induce the periodic dorsiflexion and the increased compression in a predetermined time cycle, wherein the predetermined time cycle includes a plurality of dorsiflexion time periods, wherein each dorsiflexion time period is followed by a rest time.

(6) The device of (3), wherein the dorsiflexion time period is between 0.1 seconds and 0.5 seconds and the rest time period is at least 10 seconds.

(7) The device of (1)-(6) wherein the foot support assembly comprises a frame, wherein the dorsiflexion inducing member comprises an inflatable bladder configured and dimensioned to move the foot away from the frame when the foot support assembly is worn by the patient and the bladder is inflated.

(8) The device of (7) wherein the inflatable bladder is disposed between the frame and the foot.

(9) The device of (7)-(8) wherein the inflatable bladder is inflatable to a wedge-shaped configuration.

(10) The device of (7)-(9) wherein the inflatable bladder comprises a foot engaging surface that is configured and dimensioned to engage a ball of the patient's foot when the foot support assembly is worn by the patient, wherein at a peak inflation point the bladder terminates at a position that is distal of a heel pad of the foot.

(11) The device of (7)-(10) wherein the inflatable bladder configured to retain a minimum positive pressure throughout the periodic time cycle.

(12) The device of (11) wherein the minimum positive pressure is one of: i) at least 10 mmHg; ii) about 10 mmHg; or iii) from about 10 mmHg to about 15 mmHg.

(13) The device of (10) wherein the inflatable bladder is further configured to induce a bottom of the patient's foot to form a maximum angle with respect to the frame of about 30 degrees to about 45 degrees when the inflatable bladder is fully inflated.

(14) The device of (10) wherein the inflatable bladder is configured to induce dorsiflexion of the patient's foot of about 30 degrees to about 45 degrees.

(15) The device of (7)-(13) wherein the compression member comprises a compression wrap, disposable around a portion of the patient's foot and around a portion of the frame, configured to elastically move the foot toward the frame.

(16) The device of claim (16), wherein the compression wrap applies a pressure of at least 100 mmHg to the patient's foot

(17) The device of (1)-(16) wherein the foot support assembly is configured to position the patient's foot at about 5 degrees to about 10 degrees of plantar flexion in an at-rest position and induce periodic dorsiflexion in a fully flexed position of about 35 degrees to about 55 degrees relative to the at-rest position.

(18) The device of (16) wherein the foot support assembly is configured to include a substantially rigid frame having a foot support component coupled to an ankle support component, the substantially rigid frame configured to remain in a substantially undeflected position relative to the ankle support component throughout periodic urging of the patient's foot into dorsiflexion.

(19) The device of (7)-(18) further comprising a head unit comprising a compressed air tank, coupled to the inflatable bladder, configured to release compressed air to the inflatable bladder in periodic bursts having a duration of about 0.5 seconds.

(20) The device of (7)-(19) further comprising a head unit having a compressed air tank coupled to the inflatable bladder, the compressed air tank configured to operate at a tank pressure of about 20 psi to about 25 psi.

(21) The device of (1)-(20) wherein the device produces a reverse flow velocity index in a venous valve sinus of the patient during periods when the device is operated to induce dorsiflexion, the reverse flow velocity index being one of a) about −10 to about −30; b) about −10; c) about −20; or d) about −30.

(22) The device of (1)-(21) wherein the device produces a forward flow velocity index in a venous valve sinus of the patient during periods when the device is operated to induce dorsiflexion, the forward flow velocity index being one of a) about +10 to about +30; b) about +10; c) about +20; or d) about +30.

(23) The device of (1)-(22) wherein the device produces a forward flow velocity index in a venous valve sinus of the patient and a simultaneous reverse flow velocity index in the venous valve sinus of the patient during periods when the device is operated to induce dorsiflexion.

(24) The device of (23) wherein a difference between the reverse flow velocity index and the simultaneous forward flow velocity index during the periods when the device is operated to induce dorsiflexion includes a range of from about 30 to about 50.

(25) The device of (1)-(24) wherein the foot support assembly is configured to produce a peak area of reversing flow in the venous valve sinus of at least 50% of the valve sinus area, wherein the peak area is the largest area of the valve experiencing reversing flow during the periodic dorsiflexion.

(26) The device of (1)-(25) wherein the foot support assembly is configured to produce a mean venous valve sinus reversing flow of at least 0.5 mL/s-cm².

(27) The device of (7) further comprising a high ankle securement configured to secure the frame to the patient's leg at a high ankle of the patient at about 3 inches to about 7 inches above a bottom of the patient's foot.

(28) The device of (1)-(27) wherein the periodic dorsiflexion and compression is configured to induce the co-expressions of THBD and EPCR on a peri-valvular endothelial cell surface within veins of the patient.

In an embodiment, the present invention can provide a method of preventing deep vein thrombosis (DVT) by inducing dorsal flexion of a foot. The method can include securing the foot of an immobile patient to a frame, positioning a bladder between a bottom of the foot and the frame, and inflating the bladder to cause dorsal flexion of the foot against the frame. The method can further include securing the foot to the frame via a compression band. The frame can be a substantially rigid frame and can be configured to position the foot at about 5 degrees to about 10 degrees of plantar flexion in an at-rest position and induce periodic dorsiflexion in a fully flexed position of about 35 degrees to about 55 degrees relative to the at-rest position. In an embodiment, the bladder is wedge shaped, and can be inflated to cause dorsal flexion of the foot in time intervals ranging from about 0.25 seconds to 1.00 second. The method can include monitoring an air pressure within the bladder via an air pressure monitor. In an embodiment, causing dorsal flexion of the foot relative to the frame can induce venous oscillatory flow in a leg and the foot of the immobile patient. The method can include deflating the bladder to return the foot to a plantar flexion position. Deflating the bladder can include retaining a threshold positive pressure in the deflated bladder.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 15%, up to 10%, up to 5%, or up to 1% of a given value. Alternatively, particularly with respect to biological systems or processes, the term can mean an order of magnitude, preferably within five-fold, and more preferably within two-fold, of a value.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, methods, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, and methods.

Patents, patent applications publications product descriptions, and protocols are cited throughout this application the disclosures of which are incorporated herein by reference in their entireties for all purposes.

1. A venous thromboembolism mitigation device for generating venous valve oscillatory flow in the leg veins of an immobile person, comprising:
a foot holster having a flexion pad,
an ankle brace, disposed on the foot holster,
a compression holder, disposed on the ankle brace,
an actuator configured to flex the top of the foot dorsally into the compression holder in time intervals ranging from about 0.25 seconds to 1.00 second;
wherein simultaneous rapid flexion and compression induced by the device generates the venous valve oscillatory flow in the leg veins of the immobile person to preserve the natural mechanism of deep vein thrombosis (DVT) prevention associated with muscular activity.

2. The mitigation device of claim 1, wherein the actuator is selected from the group consisting of a mechanical actuator, a pneumatic actuator, a hydraulic actuator or an electric actuator.

3. A method of generating anti-thrombotic oscillatory flow in the venous valve sinus of an immobile person, using a venous thromboembolism mitigation device that flexes and compresses and immobile person's foot, comprising:
attaching the device to a foot of the immobile person;
determining an optimal speed and extent of flexion and compression of the foot to generate the venous valve oscillatory flow in leg veins of the person; and
applying the optimal speed and extent of flexion and compression of the foot to the device.

4. A venous thromboembolism mitigation device for generating venous valve oscillatory flow in veins of a wearer of the device, comprising:
an inflation bladder, disposed within a wearable frame, adapted to inflate and deflate such that simultaneous flexion and compression induced by the inflation bladder induces venous valve oscillatory flow in the wearer.

5. The mitigation device of claim 4 further comprising a head unit, pneumatically coupled to the inflation bladder, adapted to drive inflation and deflation of the inflation bladder.

6. The mitigation device of claim 5, wherein the head unit further comprises an air compressor and a compressed air tank, wherein the air compressor is adapted to fill the compressed air tank with compressed air to a pre-determined pressure and the compressed air tank is adapted to release the compressed air to the inflation bladder.

7. The mitigation device of claim 6, wherein the head unit further comprises a solenoid valve, adapted to regulate the release of the compressed air from the compressed air tank to the inflation bladder.

8. The mitigation device of claim 6, wherein the head unit further comprises at least one pressure sensor, adapted to monitor air pressure of the compressed air tank and restore the air pressure to the pre-determined level.

9. The mitigation device of claim 6, wherein the head unit further comprises at least one pressure relief valve, adapted to monitor air pressure of the inflation bladder and prevent over-inflation thereof.

10. The mitigation device of claim 6, wherein the head unit further comprises a control board, adapted to initiate inflation of the inflation bladder and to control parameters of inflation.

11. The mitigation device of claim 6, wherein the head unit further comprises an alarm system, adapted to detect a mechanical malfunction and to provide an audible alert in response to the mechanical malfunction.

12. The mitigation device of claim 4, wherein the wearable frame comprises a rigid plastic frame, configured to attach to a foot of the wearer and to extend to an ankle of the wearer, and a compression band, configured to secure the foot to the rigid plastic frame.

13. The mitigation device of claim 4, wherein the inflation bladder is adapted to be deflated to 10 mmHg such that the inflation bladder can be re-inflated.

14. A device for mitigating thromboembolism in a patient, the device comprising:
a foot support assembly comprising:
a dorsiflexion inducing member configured to move a foot of the patient into periodic dorsiflexion; and
a compression member configured to increase compression on a portion of the foot during the periodic dorsiflexion.

15. The device of claim 14, wherein the foot support assembly is configured to induce venous valve oscillatory flow in a leg of the patient.

16. The device of claim 14, wherein the foot support assembly is configured to induce venous oscillatory shear stress in a leg of the patient.

17. The device of claim 14, wherein the foot support assembly is configured to place the foot in a rest position, wherein the dorsiflexion inducing member is engaged with a ball of the foot while the foot is in plantarflexion and the compression member provides a minimum level of pressure to the foot, and a dorsiflexed position, wherein the dorsiflexion inducing member applies pressure to the ball of the foot in a dorsiflexed position and the compression member provides a maximum level of pressure to the foot that exceeds the minimum level of pressure.

18. The device of claim 14 further comprising a controller, coupled to the foot support assembly, configured to induce the periodic dorsiflexion and the increased compression in a predetermined time cycle, wherein the predetermined time cycle includes a plurality of dorsiflexion time periods, wherein each dorsiflexion time period is followed by a rest time period, wherein each of the dorsiflexion time periods being of substantially uniform duration.

19. The device of claim 13, wherein the foot support assembly comprises a frame, wherein the dorsiflexion inducing member comprises an inflatable bladder configured and dimensioned to move the foot away from the frame when the foot support assembly is worn by the patient and the bladder is inflated.

20. The device of claim 19, wherein the inflatable bladder comprises a foot engaging surface that is configured and dimensioned to engage a ball of the patient's foot when the foot support assembly is worn by the patient, wherein at a peak inflation point the bladder terminates at a position that is distal of a heel pad of the foot.

21. The device of claim 20, wherein the inflatable bladder is further configured to induce a bottom of the patient's foot to form a maximum angle with respect to the frame of about 30 degrees to about 45 degrees when the inflatable bladder is fully inflated.

22. The device of claim 20 wherein the inflatable bladder is further configured to induce dorsiflexion of the patient's foot of about 30 degrees to about 45 degrees relative to a neutral position of the foot where the foot is at an angle of approximately 90 degrees relative to the patient's tibia.

23. The device of claim 19, wherein the inflatable bladder is further configured to retain a minimum positive pressure throughout the predetermined time cycle.

24. The device of claim 19, wherein the compression member comprises a compression wrap, disposable around a portion of the patient's foot and around a portion of the frame, configured to elastically move the foot toward the frame.

25. The device of claim 14, wherein the foot support assembly is configured to position the patient's foot at about 5 degrees to about 10 degrees of plantar flexion in an at-rest position and induce periodic dorsiflexion in a fully flexed position of about 35 degrees to about 55 degrees relative to the at-rest position.

26. The device of claim 25, wherein the foot support assembly comprises:
a substantially rigid frame comprising:
a foot support component; and
an ankle support component, coupled to the foot support component;
wherein the substantially rigid frame is configured to remain in a substantially undeflected position relative to the ankle support component throughout periodic urging of the patient's foot into dorsiflexion.

27. The device of claim 19 further comprising:
a head unit comprising:
a compressed air tank, coupled to the inflatable bladder, configured to release compressed air to the inflatable bladder in periodic bursts having a duration of about 0.5 seconds.

28. The device of claim 19 further comprising:
a head unit comprising:
a compressed air tank, coupled to the inflatable bladder, configured to operate at a tank pressure of about 20 psi to about 25 psi.

29. The device of claim 14, wherein the foot support assembly is configured to produce a reverse flow velocity index in a venous valve sinus of the patient during the periodic dorsiflexion.

30. The device of claim 29, wherein the reverse flow velocity index is between about −10 and about −30.

31. The device of claim 14, wherein the foot support assembly is configured to produce a forward flow velocity index in a venous valve sinus of the patient during the periodic dorsiflexion.

32. The device of claim 31, wherein the forward flow velocity index is between about +10 and about +30.

33. The device of claim 14, wherein the foot support assembly is configured to produce a forward flow velocity index in a venous valve sinus of the patient and a simultaneous reverse flow velocity index in the venous valve sinus of the patient during the periodic dorsiflexion.

34. The device of claim 33, wherein a difference between the reverse flow velocity index and the simultaneous forward flow velocity index during the periodic dorsiflexion is between about 30 and about 50.

35. The device of claim 14, wherein the foot support assembly is configured to produce a peak area of reversing flow in the venous valve sinus of at least 50% of the valve sinus area, wherein the peak area is the largest area of the valve experiencing reversing flow during the periodic dorsiflexion.

36. The device of claim 14, wherein the foot support assembly is configured to produce a mean venous valve sinus reversing flow of at least 0.5 mL/s-cm².

37. The device of claim 19 further comprising a high ankle securement configured to secure the frame to the patient's leg at a high ankle of the patient at between about 3 inches and about 7 inches above a bottom of the patient's foot.

38. The device of claim 14, wherein the periodic dorsiflexion and the increased compression induce the co-expressions of THBD and EPCR on a perivalvular endothelial cell surface within veins of the patient.

39. A method of mitigating venous thromboembolism in a patient comprising:
applying a force to a ball of the patient's foot to induce dorsiflexion in a repeating time cycle characterized by periods of dorsiflexion each followed by a rest period, wherein the periods of dorsiflexion are less than 1 second; and
applying progressively increased compression to the patient's foot during the periods of dorsiflexion.

40. A method of preventing deep vein thrombosis (DVT) by inducing dorsal flexion of a foot, the method comprising:
securing the foot of an immobile patient to a frame;
positioning a bladder between a bottom of the foot and the frame; and
inflating the bladder to cause dorsal flexion of the foot against the frame.
